(19) United States
(12) Patent Application Publication
(10) Pub. No.: US 2015/0123038 A1
(43) Pub. Date: May 7, 2015

(54) ADVANCED OFF-GAS RECOVERY PROCESS AND SYSTEM

(71) Applicant: centrotherm photovoltaics USA, Inc, Poulsbo, WA (US)

(72) Inventor: Mark William Dassel, Poulsbo, WA (US)

(21) Appl. No.: 14/397,479

(22) PCT Filed: Apr. 26, 2013
(86) PCT No.: PCT/US2013/038519

§ 371 Date: Oct. 27, 2014

Related U.S. Application Data
(60) Provisional application No. 61/639,810, filed on Apr. 27, 2012.

(51) Int. Cl. C01B 33/107; B01J 19/24; B01D 53/02; C01B 3/06

(52) U.S. Cl. CPC C01B 33/10757; C01B 3/065; B01J 19/24; B01D 53/02; B01J 2219/24; B01D 2253/106; B01D 2257/20; B01D 2257/55
USPC 252/372; 423/341; 423/658.2; 422/187; 96/108

(57) ABSTRACT

A process that includes: (a) introducing a vent gas comprising hydrochloric acid, silicon tetrachloride, trichlorosilane, and dichlorosilane to an HCl converter reactor comprising a metal catalyst, to provide a product gas comprising less hydrochloric acid than was present in the vent gas; (b) refining the product gas to provide a hydrogen enriched stream and a chlorosilane(s) enriched stream, and (c) introducing the chlorosilane(s) enriched stream into a TCS/STC distillation unit, to generate a fraction enriched in silicon tetrachloride and another fraction enriched in trichlorosilane and dichlorosilane.

### FIELD OF THE INVENTION

The present invention relates generally to chemical processes and systems, and more specifically to chemical processes and systems that produce trichlorosilane to thereby afford economical access to polysilicon useful in the manufacture of photovoltaics, semiconductors and integrated circuits.

### BACKGROUND

A gas stream comprising trichlorosilane (TCS), silicon tetrachloride (STC), dichlorosilane (DCS), hydrogen chloride (HCl), and hydrogen (H₂) is a by-product of the chemical vapor deposition (CVD) process known in the industry as the Siemens process, whereby DCS and/or TCS is converted to polysilicon. This gas stream is commonly referred to by various names, including off gas, off gas stream, vent gas, vent gas stream, and process vent gas stream. The components of this gas stream are recovered and isolated, and then either used directly as feedstock for the Siemens process, or converted to materials that can serve as feedstock for the Siemens process. For example, the DCS and TCS in the vent gases can be recovered and directly recycled to the CVD reactor for increased process yield. For instance, once separated, the TCS and DCS so recovered are commonly vaporized with a heating medium (e.g., steam) or by heat interchange with hot CVD vent gases, and mixed with recycle hydrogen gas. At this point, these are then co-fed into the CVD reactor. As another example, STC in the off-gas can be converted to TCS which, optionally after supplemental purification, may be similarly recycled to the CVD reactor for increased yield. As a further example, HCl recovered from the off-gas can be used to convert metallurgic silicon to TCS for conversion to polysilicon in the CVD reactor. Accordingly, it is known in the art to separate and store the components of the off gas from the Siemens process (DCS, TCS, STC, HCl, H₂, etc.) for such uses. In general, this approach to the recovery and re-use of the process vent gases requires high capital cost, high operating cost, and high maintenance cost.

### SUMMARY

In one embodiment, the present disclosure provides a replacement for the current, complex vent gas recovery (VGR) system used in polysilicon and related manufacturing processes with a greatly simplified system and process, thereby reducing both capital investment and operating cost by as much as 80%. In this embodiment, system and process simplification is accomplished by two means: (1) substantially reducing or eliminating HCl from the vent gas stream, and (2) combining multiple process steps into one simple unit operation. More specifically, HCl may be removed from the vent gas stream by using in situ HCl reaction technology. The process comprises contacting a vent gas comprising hydrogen chloride and a (i.e., at least one) hydrochlorosilane described by the formula HₐSiCl₄₋ₐ where a=1 to 3, with a chlorination catalyst at a temperature within a range of about 30° C. to 700° C. in an HCl converter reactor, thereby effecting substitution of silicon-bonded hydrogen with chlorine to form a more highly chlorinated silane. The resulting HCl depleted gas is then used as a feedstock for further systems and processes. For example, the resulting HCl depleted gas may be subjected to a separation process whereby hydrogen in the gas is largely separated from chlorosilanes in the gas. Suitable separation processes include an absorber column and a refrigerated condenser system. Regardless of how the separation is achieved, the chlorosilanes are introduced to a distillation unit whereby TCS/DCS is separated from STC. As used herein “TCS/DCS” and the like refers to a mixture of the named materials, in this case TCS and DCS.

More specifically, in one embodiment the present disclosure provides a VGR process which comprises:
a) introducing a vent gas comprising hydrogen, hydrochlorosilane and hydrochloric acid to an HCl converter reactor comprising a metal catalyst, and contacting the vent gas with the metal catalyst to provide a product gas that is depleted in HCl, i.e., that comprises less hydrochloric acid than was present in the vent gas, and then removing the product gas from the reactor, where in optional embodiments of this step through the present disclosure, the products gas has less than 0.1 wt %, or less than 0.5 wt %, or less than 1 wt % hydrochloric acid;
b) separating components of the product gas to provide a first fraction enriched in hydrogen and a second fraction enriched in chlorosilanes; and
c) introducing the second fraction to a distillation unit to separate the second fraction into a third fraction enriched in TCS/DCS and a fourth fraction enriched in STC. As used herein and through the present disclosure, a fraction that is enriched in a named component or components will have a greater weight percent of that named component or components than does the starting material from which the fraction derived.

For example, in one embodiment the present disclosure provides a VGR process which comprises:
a) introducing a vent gas comprising hydrogen, hydrochlorosilane and hydrochloric acid to an HCl converter reactor comprising a metal catalyst, and contacting the vent gas with the metal catalyst to provide a product gas that is depleted in HCl, i.e., that comprises less hydrochloric acid than was present in the vent gas, and then removing the product gas from the reactor;
b) introducing the product gas from step a) into the bottom of an absorber column, introducing reflux comprising at least one of TCS and STC into the top of the absorber column, withdrawing a second fraction as a liquid bottoms stream comprising TCS and STC from the bottom of the absorber column, and withdrawing a first fraction as a gas stream comprising hydrogen and one or both of TCS and STC from the top of the absorber; and
c) introducing the second fraction liquid bottoms stream from step b) into a TCS/STC distillation unit, to generate a third fraction enriched in trichlorosilane and dichlorosilane, and a fourth fraction enriched in silicon tetrachloride.

As another example, in one embodiment the present disclosure provides a VGR process which comprises:
a) introducing a vent gas comprising hydrogen, hydrochlorosilane and hydrochloric acid to an HCl converter reactor comprising a metal catalyst, and contacting the vent gas with the metal catalyst to provide a product gas that is depleted in HCl, i.e., that comprises less hydrochloric acid than was present in the vent gas, and then removing the product gas from the reactor;
b) introducing the product gas from step a) into the bottom of an absorber column, introducing reflux comprising TCS into the top of the absorber column, withdrawing a second fraction as a liquid bottoms stream comprising TCS and STC from the bottom of the absorber column, and withdrawing a first fraction as a gas stream comprising hydrogen and one or both of TCS and STC from the top of the absorber; and
c) introducing the second fraction/liquid bottoms stream from step b) into a TCS/STC distillation unit, to generate a third fraction enriched in trichlorosilane and dichlorosilane, and a fourth fraction enriched in silicon tetrachloride. As used herein, a fraction that is enriched in a named component or components will have a greater weight percent of that named component or components than does the named starting material from which it is derived.

For example, in one embodiment the present disclosure provides a VGR process which comprises:
a) introducing a vent gas comprising hydrogen, hydrochlorosilane and hydrochloric acid to an HCl converter reactor comprising a metal catalyst, and contacting the vent gas with the metal catalyst to provide a product gas that is depleted in HCl, i.e., that comprises less hydrochloric acid than was present in the vent gas, and then removing the product gas from the reactor;
b) introducing the product gas from step a) into the bottom of an absorber column, introducing reflux comprising STC into the top of the absorber column, withdrawing a second fraction as a liquid bottoms stream comprising TCS and STC from the bottom of the absorber column, and withdrawing a first fraction as a gas stream comprising hydrogen and one or both of TCS and STC from the top of the absorber; and
c) introducing the second fraction/liquid bottoms stream from step b) into a TCS/STC distillation unit, to generate a third fraction enriched in trichlorosilane and dichlorosilane, and a fourth fraction enriched in silicon tetrachloride.

In yet still another embodiment, the present disclosure provides a process comprising:
a) introducing a vent gas comprising hydrogen, hydrochlorosilane and hydrochloric acid to an HCl converter reactor comprising a metal catalyst, and contacting the vent gas with the metal catalyst to provide a product gas that is depleted in HCl, i.e., that comprises less hydrochloric acid than was present in the vent gas, and then removing the product gas from the reactor;
b) introducing the product gas into a refrigerated condenser system, to generate a first fraction enriched in hydrogen and a second fraction enriched in silicon tetrachloride, trichlorosilane and dichlorosilane.
c) introducing the second fraction from step b) into a TCS/STC distillation unit, to generate a third fraction enriched in trichlorosilane and dichlorosilane, and a fourth fraction enriched in silicon tetrachloride.

The following describes optional embodiments for the aforesaid VGR process of steps a), b) and c). One or more of steps a), b) and c) in the process, and/or one or more intermediate steps between steps a) and b), and/or one or more intermediate steps between steps b) and c), are operated at super-ambient conditions. For example, contacting a vent gas comprising hydrochloric acid, silicon tetrachloride, trichlorosilane, and dichlorosilane with a metal catalyst is performed at super-ambient temperature, and the product gas, and optionally all of the product gas, is maintained at super-ambient temperature, and optionally entirely in the gas phase, between exiting the HCl converter reactor of step a) and entering the absorber column or refrigerated condenser system of step b). As another example, introducing the product gas from step a) into the bottom of an absorber column of step h), to provide a gas stream comprising hydrogen and trichlorosilane, or hydrogen and silicon tetrachloride depending on the selection for the reflux component, and a liquid stream comprising chlorosilanes, and removing the liquid stream from the absorber column are all performed at super-ambient temperature, and the liquid bottoms stream is maintained at super-ambient temperature between exiting the absorber column of step b) and entering the TCS/STC distillation unit of step c). As yet another example, introducing the liquid bottoms stream into a TCS/STC distillation unit according to step c), to generate a third fraction enriched in TCS and DCS, and a fourth fraction enriched STC, is performed at super-ambient temperature.

Also optionally, when the separation of the product gas into fractions is accomplished by way of an absorber column and TCS is a reflux component of the reflux introduced into the absorber column, then H₂ saturated with TCS (i.e., a gas stream comprising hydrogen and TCS obtained from the top of the absorber) may go straight to the CVD reactor, or alternately it may go to a refrigerated condenser system to condense out substantially all of the TCS from the H₂ recycle. Likewise, when STC is used as a reflux component of the reflux introduced into the absorber, then the resulting H₂ saturated with STC (i.e., a gas stream comprising hydrogen and STC obtained from the top of the absorber) may be directed into a refrigerated condenser system in order to separate H₂ from STC. Thereafter, the gas stream from the refrigerated condenser system may optionally be directed into a CVD reactor. The pressure of the gas leaving the absorber may optionally be increased to a pressure of about 9 barg in the compressor, where the pressure of the gas leaving the absorber may be about 5-7 barg. Because the amount of STC in the H₂ gas stream leaving the absorber column at 35° C. (a temperature exemplary of a super-ambient temperature) is approximately equal to the amount of STC in the vent gas leaving the CVD reactor, if the refrigerated condenser system is omitted, then an excessive amount of STC would be present in the H₂ recycle that is directed back to the CVD reactor. Because STC is a by-product of the CVD reaction, utilizing a H₂ feed with an excessive amount of STC in it would have a deleterious effect on the decomposition reaction. When it is desired to remove chlorosilane from the gas stream comprising hydrogen and chlorosilane (TCS and/or STC) obtained from the top of the absorber, it is much easier to condense out STC than TCS due to the higher boiling point of STC (57° C. at atmospheric pressure) relative to that of TCS (31° C. at atmospheric pressure). Accordingly, when it is desired to obtain a purified H₂ stream from the gas stream comprising hydrogen and chlorosilane obtained from the top of the absorber, it is advantageous to use STC as the reflux component of the reflux introduced into the absorber in conjunction with a subsequent refrigerated condenser system, and one embodiment of the present disclosure provides this optional process. The purification of TCS from the gas stream comprising hydrogen and TCS obtained from the top of the absorber is optional and not a necessary step of the present process.

This process is highly advantageous because it may accomplish one or more of the following: it eliminates the requirement for the HCl absorption step utilized in most commercial polysilicon production plants, whereby HCl, which would otherwise be in the vent gas stream, is absorbed out of the gas phase into an extremely cold liquid comprising mixed chlorosilanes; it eliminates the HCl distillation step where the extremely cold chlorosilane absorbent stream is separated from absorbed HCl, yielding a pure HCl stream and a stream containing TCS, DCS and STC; and/or it eliminates the requirement for a refrigerated condensing step where HCl gas, having been separated from chlorosilane absorbent, is condensed into a liquid state and stored as a refrigerated liquid. Thus, in one aspect, the process and systems of the present disclosure omit a step of cooling or liquefying an HCl-containing gas stream.

The operation of the HCl absorption system and subsequent HCl distillation system mentioned above is hard to control and prone to process upset. By way of contrast, the process of the present disclosure is easy to control and operationally robust. In one embodiment, the VGR system of the present disclosure requires only three steps, although optional steps, including optional steps intermediate between or following steps a), b) and c), may also be included in the process. Any of the steps a), b) and/or c) may also be described as:
Step a) is an in situ HCl reaction, whereby HCl is consumed and the Cl atoms from HCl converted to other molecular species, e.g., chlorosilane(s);
Step b1) is, in one embodiment, an absorption step, whereby certain vent gas components are concentrated and/or separated from one another in an absorber;

Step b2) is, in one embodiment, a refrigerated condensing step, whereby certain vent gas components are concentrated and/or separated from one another in a refrigerated condenser system; where step b) can be either one of steps b1) and b2) or both of steps b1 and b2; and

Step c) is a distillation step, whereby mixed chlorosilanes, for example, from the bottoms stream leaving the absorber or from the condensate leaving the refrigerated condenser system, are separated into an STC stream and a stream comprising DCS and TCS.

As mentioned above, in an optional embodiment, the process is operated at super-ambient temperature. In other words, the components of the vent gas are maintained at one or more temperatures in excess of the environmental temperature within which the plant is located and being operated. In a further optional embodiment, there is no need to cool the chlorosilane gas components, in the vent gas, into a liquid state prior to introducing them to the absorber. Stated differently, in one embodiment of the process of the present disclosure, vent gas is maintained entirely in a gas state between exiting the HCl converter reactor and entering the absorber column. This is advantageous because the absorber receives a liquid reflux, either STC or TCS, and this liquid reflux must be vaporized within the absorber. If the vent gas entering the absorber is entirely in the gas state, then the vent gas has more energy which can be used to vaporize the liquid reflux, in comparison to the situation where the vent gas has been partially converted to a liquid phase prior to entering the absorber column. It is also advantageous to have relatively more vent gas entering the absorber column, since a higher quantity of vent gas will have a higher quantity of heat which may be used to vaporize the reflux, all other factors remaining constant. Accordingly, in one optional embodiment, all of the vent gas that exits the HCl converter reactor is delivered to the absorber, and the vent gas entering the absorber column is entirely in the gas phase.

In another embodiment, a process is provided for producing polysilicon in a CVD reactor whereby a first feedstock stream containing a high concentration of TCS is derived from the vent gases exiting a polysilicon-producing CVD reactor. Preferably, this first feedstock stream has not, since exiting the CVD reactor, been in liquid form, and/or it has been maintained at super-ambient temperature. This feedstock stream is a mixture comprising trichlorosilane and hydrogen (H₂), where the trichlorosilane constitutes at least 5 mol % of the feedstock stream, up to about 50 mol %, and normally 15-25 mol %. This feedstock stream may be combined with a second feedstock stream comprising vaporized TCS, i.e., TCS which was formerly in the liquid state but which has been converted to the gaseous state. The combination of the first and second feedstock streams provides a final feedstock that can directly enter a polysilicon-producing CVD reactor (i.e., a starting feedstock for the CVD reactor). Accordingly, in another embodiment of a process of the present disclosure, a process is described as comprising:
a) combining feedstocks comprising a first and a second feedstock, to provide a starting feedstock, where the first feedstock comprises a mixture of trichlorosilane and hydrogen and the trichlorosilane constitutes between 5 and 50 mol % of the first feedstock; and
b) introducing the starting feedstock to a CVD reactor to generate polysilicon.

In another embodiment, a process is provided for refining and purifying the process vent gas from a CVD reactor for polysilicon production so that it (the process vent gas) may be used to create higher purity polysilicon, i.e., higher purity than would otherwise be obtained, absent the refining process described herein. The refining process has, as a principle objective, the removal of impurities from the feedstock used for a CVD reactor, and accordingly the production of a polysilicon product having reduced impurities. Boron, for example in the form of boron trichloride, is an impurity that can be isolated and removed from the vent gas, according to an optional embodiment of the present process. In fact, the boron content in a polysilicon product produced by the Siemens process can be reduced by as much as 4× to 10× or more using feedstocks derived from the from vent gas as described herein. As will be shown below, a key discovery is a means of absorbing the preponderance of the boron, introduced into the system with refined TCS makeup, out of the CVD vent gas into a disposable silica gel. Since according to the teachings herein, only 5% to 20% of the boron in the feed to the CVD reactor is deposited in the polysilicon product per pass through the CVD reactor, boron builds up in the process gas stream. By methods described herein, boron may be absorbed onto silica gel, thereby quantitatively removing it from recycle streams back to the CVD reactor, thereby reducing boron content in the polysilicon product by a factor of 4× to 10×. The silica gel bed may be regenerated if desired. Those versed in the art will recognize the great utility made possible by this disclosure in reducing boron in polysilicon product.

According to this embodiment for reducing boron content in polysilicon, a process is provided comprising:
a) preparing a feedstock by a process comprising combining a first feedstock comprising primarily hydrogen and a second feedstock comprising primarily chlorosilane, where the second feedstock comprises boron and has a first boron content;
b) delivering the feedstock to a polysilicon-producing CVD reactor;
c) obtaining a vent gas from the CVD reactor;
d) exposing the vent gas or a fraction thereof that has been enriched in boron content, where the vent gas or the fraction thereof has a second boron content, to silica gel to provide a feedstock component having a third boron content, where the third boron content is less than the second boron content;
e) combining the feedstock component produced in step d) with reactants comprising hydrogen and the second feedstock to provide a third feedstock; where the third feedstock has a fourth boron content which is less than the first boron content; and
f) introducing the third feedstock to the polysilicon-producing CVD reactor.

The embodiment for reducing boron content in polysilicon may be used in combination with other embodiments of the processes described herein. For example, the vent gas from the CVD reactor may be separated into a third fraction enriched in trichlorosilane and/or dichlorosilane and a fourth fraction enriched in silicon tetrachloride, and the third fraction is exposed to the silica gel. The third and fourth fractions are prepared according to one or more of the chlorination, absorption, refrigerated condensation, and distillation steps described herein. For example, the vent gas may be treated with a metal catalyst to provide a product gas containing less than 0.1 wt %, or less than 0.5 wt % or less than 1 wt % hydrochloric acid, and the product gas or a fraction thereof is exposed to silica gel to reduce boron content. The passage of vent gas, or a vent gas fraction, through silica gel, causes absorption of boron impurities from the vent gas or fraction thereof, into the silica gel. The gas leaving the silica gel, referred to above as the feedstock component, is therefore depleted in boron, having a third boron content. Viewed another way, the gas leaving the silica gel will have a ratio of boron to chlorosilane, as measured in weight or moles, that is less than the same ratio as measured for the gas entering the silica gel. When this feedstock component, which is depleted in boron, is combined with fresh TCS and fresh hydrogen to provide a feedstock for a CVD reactor to make polysilicon, this resulting feedstock will have less boron, i.e., a lower ratio of boron to TCS, than if only fresh TCS and fresh hydrogen were combined, assuming that the fresh TCS has the usual boron content, i.e., a first boron content, which is greater than that of the feedstock component that is depleted in boron, which has a third boron content.

As mentioned previously, the present disclosure provides a process comprising:
a) introducing a vent gas comprising hydrogen, hydrochlorosilane and hydrochloric acid to an HCl converter reactor comprising a metal catalyst, and contacting the vent gas with the metal catalyst to provide a product gas comprising less hydrochloric acid than was present in the vent gas, and removing the product gas from the reactor;
b) separating components of the product gas to provide a first fraction enriched in hydrogen and a second fraction enriched in chlorosilanes; and
c) introducing the second fraction into a distillation unit, to provide a third fraction enriched in TCS/DCS and a fourth fraction enriched in STC.

After formation of the third and fourth fractions, these fractions may be utilized in a process and/or system of the present disclosure as identified below. In the embodiments described below, some are more applicable when the separation step b) proceeds by way of an absorber column, while others are more applicable when the separation step b) proceeds by way of a refrigerated condenser system. However, even if the separation of first and second fractions proceeds by way of an absorber column, a refrigerated condenser system may still be optionally included in the process and/or system of the present disclosure. The various optional embodiments provided below may include a reference number set within parenthesis, where those numbers refer to specific operational units as utilized in the FIGS. 1A-11. These reference numbers are provided as an aid to the reader and are not to be interpreted as limiting on the present disclosure. In addition, after each of the various optional embodiments, one or more specific Figures are identified that illustrate the use of the optional feature or embodiment in the context of the VGR system and process of the present disclosure, where these reference Figures are intended to be non-limiting on the present disclosure and are provided merely as an aid to the reader in understanding the various optional embodiments and how they may be optionally be combined. The various optional embodiments are provided below, where any two or more of the embodiments may be combined to describe a process of the present disclosure.
1) the third fraction comprising TCS/DCS, optionally after being stored in a tank, e.g., tank (28) or tank (44), is combined with hydrogen to provide a feedstock for a CVD reactor wherein polysilicon is produced; see, e.g., FIG. 1A and FIG. 8A.
2) the third fraction comprising TCS/DCS may be stored until it is needed in the plant, e.g., it may be stored in a tank (22) until it is used as reflux in an absorber column (18); see, e.g., FIG. 1A.
3) the third fraction comprising TCS/DCS is contacted with a silica gel bed, e.g., (40), where the silica gel absorbs boron from the third fraction and a boron-depleted fifth fraction comprising TCS/DCS is produced; see, e.g., FIG. 2, FIG. 5A and FIG. 9.
   a) the fifth fraction comprising TCS/DCS is directed to a gas compressor (24) and may ultimately utilized as feedstock in a CVD reactor; see, e.g., FIG. 2 and FIG. 9.
   b) the fifth fraction comprising TCS/DCS is combined with hydrogen to provide a feedstock to a CVD reactor, optionally after passing through a condenser (42) and/or a storage tank (44); see, e.g., FIG. 2, FIG. 5A and FIG. 9.
4) the third fraction comprising TCS/DCS is separated in a distillation unit into a sixth fraction enriched in TCS and a seventh fraction enriched in DCS; see, e.g., FIG. 3, FIG. 4, FIG. 6, FIG. 7, FIG. 10 and FIG. 11.
   a) the sixth fraction comprising TCS may be directed to a storage tank (22) to be used as reflux for an absorber (18) or for any other purpose for which TCS may be needed in the plant; see, e.g., FIG. 3.
   b) the sixth fraction comprising TCS, optionally after being stored in a tank, e.g., tank (28), is combined with hydrogen to provide a feedstock for a CVD reactor wherein polysilicon is produced; see, e.g., FIG. 3, FIG. 4, FIG. 6, FIG. 7, FIG. 10 and FIG. 11.
   c) The seventh fraction comprising DCS, which may also contain boron and/or phosphorus, is sent to a waste treatment facility; not shown in Figures.
   d) the seventh fraction comprising DCS is contacted with silica gel, and boron is absorbed from the seventh fraction into the silica gel to provide an eighth fraction comprising DCS and little or no boron; see, e.g., FIG. 3, FIG. 4, FIG. 6, FIG. 7, FIG. 10 and FIG. 11.
      i) the eighth fraction comprising DCS is directed to a gas compressor (24) and may ultimately utilized as feedstock in a CVD reactor; see, e.g., FIG. 3, FIG. 6 and FIG. 10.
      ii) the eighth fraction comprising DCS is combined with hydrogen to provide a feedstock to a CVD reactor, optionally after passing through a condenser (42) and/or a storage tank (44); see, e.g., FIG. 3, FIG. 6 and FIG. 10.
      iii) the eighth fraction comprising DCS, along with STC which may be provided, for example, by the fourth fraction, are directed to a redistribution reactor (50) to provide a ninth fraction comprising TCS and optionally minor amounts of DCS and/or STC; see, e.g., FIG. 4, FIG. 7 and FIG. 11.
5) the fourth fraction comprising STC is directed to an STC converter; not shown in Figures.
6) the fourth fraction comprising STC is directed to an STC hydrochlorinator; not shown in Figures.
7) the fourth fraction comprising STC, along with DCS which may be provided, for example, by the 8^{th} fraction, is directed to a redistribution reactor (50), to provide a ninth fraction comprising TCS and optionally minor amounts of DCS and/or STC; see, e.g., FIG. 4, FIG. 7 and FIG. 11.
8) the fourth fraction comprising STC may be directed to a storage tank, e.g., tank (22), for storage until it is needed in the plant, for example, it may be needed as reflux for absorber (18); see, e.g., FIG. 5A.

In addition to providing processes, the present disclosure also provides systems, e.g., systems that may be used to perform the processes of the present disclosure. In one embodiment, a system of the present disclosure includes i) an HCl converter reactor, i.e., a reactor that converts HCl to other molecular species, e.g., hydrogen and/or chlorosilane; ii) an absorber column; and iii) a TCS/STC distillation unit. The absorber is in fluid communication with the TCS/STC distillation unit, in other words, the absorber produces a chemical stream that either directly goes into the TCS/STC distillation unit, or indirectly goes into the TCS/STC distillation unit. In another embodiment, a system of the present disclosure includes i) an HCl converter reactor; ii) a refrigerated condenser system; and iii) a TCS/STC distillation unit; where the refrigerated condenser system is in fluid communication with and can receive vent gas exiting the HCl converter reactor, and where the TCS/STC distillation unit is in fluid communication with and can receive an effluent stream from the refrigerated condenser system.

In embodiments described herein, the processes and systems of the present disclosure may utilize or contain both an absorber column and a refrigerated condenser system. In such a case, and as also described herein, the refrigerated condenser system may receive effluent from the absorber column, and more specifically may receive a hydrogen-containing effluent that is referred to herein as the first fraction. As also mentioned herein, the processes and systems of the present disclosure may contain optional steps and operational units such as heat exchangers, storage tanks, additional distillation units, etc. However, in one optional embodiment, the systems and processes of the present disclosure exclude having an absorber column receive effluent from a refrigerated condenser system.

In another embodiment, the present disclosure provides systems and processes that include one or more of boron and phosphorous removal from the gases in the vent gas, for example, the present disclosure provides a vent gas recovery system that comprises a silica gel bed. Optionally, the vent gas recovery system further comprises an HCl converter reactor and a TSC/STC distillation unit. In a related embodiment, the present disclosure provides a system comprising: a) an HCl converter reactor which may i) receive hydrogen, HCl and trichlorosilane, ii) consume HCl, and iii) produce silicon tetrachloride in the presence of a metal catalyst; b) an absorber column which may i) receive hydrogen, trichlorosilane and silicon tetrachloride and ii) generate a first fraction comprising hydrogen and a second fraction comprising a mixture of trichlorosilane and the silicon tetrachloride; c) a TCS/STC distillation unit which may i) receive a mixture of trichlorosilane and silicon tetrachloride and ii) separate the trichlorosilane from the silicon tetrachloride; and d) a silica gel bed which may i) receive a composition comprising at least one of DCS and TCS and ii) absorb boron and/or phosphorus impurities from the composition

As used herein, a chemical stream that indirectly goes into a named system unit will pass through one or more other system units before entering the named system unit. The HCl converter is likewise in fluid communication with the absorber column. Accordingly, in one embodiment, the HCl converter is in fluid communication with an absorber column, and the absorber column is in fluid communication with a TCS/STC distillation unit.

The systems identified above and elsewhere herein may contain one or more optional units. Some exemplary optional units, and their location relative to the HCl converter reactor and/or absorber column and/or refrigerated condenser system and/or TCS/STC distillation unit are provided herein. For example, the system may include a CVD reactor. The CVD reactor may be in fluid communication with the HCl converter, so that HCl-containing vent gas from the CVD reactor is delivered to the HCl converter reactor, where the HCl is removed from the vent gas within the HCl converter reactor by causing the HCl to react in a manner that consumes the HCl. The system may contain heat recovery equipment, such as a steam generator, which may be used to absorb heat from a gas stream, e.g., the vent gas stream exiting the HCl converter reactor. The system may contain a gas compressor. A gas compressor may be in fluid communication with the absorber column, e.g., the gas compressor may receive the hydrogen-containing gas stream that exits the top of the absorber. The system may include a silica gel bed. A silica gel bed may be in fluid communication, either directly or indirectly, with the absorber column. For example, the silica gel bed may receive a chemical stream from the gas compressor, and the gas compressor may receive a chemical stream from the absorber column. The system may include a refrigerated condenser system. A refrigerated condenser system may be in fluid communication, either directly or indirectly, with the absorber. For example, the refrigerated condenser system see, e.g., the refrigerated condenser system of FIG. 1A, FIG. 5A and FIG. 8A) may be in direct fluid communication with a silica gel bed, and the silica gel bed may be in direct fluid communication with the gas compressor, and the gas compressor may be in direct fluid communication with the absorber. The system may include a carbon absorbent bed, which may absorb carbon-containing species from a chemical stream provided herein. For example, the first fraction comprising hydrogen may be contacted with carbon absorbent to remove residual amounts of chlorosilane(s) and optionally hydrocarbon.

The system may include DCS/TCS distillation unit which receives a stream comprising both TCS and DCS and operates under conditions that achieve the separation of the TCS from the DCS so as to provide a TCS enriched stream and a DCS enriched stream. The DCS/TCS distillation unit may be in fluid communication, directly or indirectly, with the TCS/STC distillation unit. For example, the TCS/STC distillation unit operates under conditions that achieve separation of the STC from the TCS/DCS so as to produce a chemical stream comprising TSC and DSC, where this chemical stream may be directed to the DCS/TCS distillation unit in order to provide a TCS enriched stream and a separate DCS enriched stream.

The system may include a redistribution reactor. The redistribution reactor may receive feedstocks comprising DCS and STC, and in the presence of a catalyst, will produce TCS optionally in combination with DCS and/or STC. The system of the present disclosure may contain any one, or any two, or any three, or any four, or any five, or any six, or any seven or more of these optional units, in addition to the HCl converter reactor, the absorber column and/or refrigerated condenser system, and the TCS/STC distillation unit described herein.

The details of one or more embodiments are set forth in the description below. The features illustrated or described in connection with one exemplary embodiment may be combined with the features of other embodiments. Other features, objects and advantages will be apparent from the description, the drawings, and the claims. In addition, the disclosures of all patents and patent applications referenced herein are incorporated by reference in their entirety.

### BRIEF DESCRIPTION OF THE DRAWINGS

Features of the present disclosure, its nature and various advantages will be apparent from the accompanying drawings and the following detailed description of various embodiments.

FIG. 1A is a schematic block diagram for an integrated system and process including a VGR system and process of the present disclosure, including an optional CVD reactor, an HCl converter reactor, an optional steam generator which functions as an optional heat recovery unit, an optional cooling water unit which functions as an optional vent gas cooling system, a VGR system including an absorber column, e.g., an STC absorber column, an optional recycle gas compressor, e.g., a hydrogen/TCS stream compressor and de-mister from which gas may exit by either or both of a hydrogen bleed going to, for example, an STC hydrochlorination reactor, or an optional silica gel bed and then a refrigerated condenser system such as shown in FIG. 1B, a TCS/STC distillation unit for STC/TCS/DCS separation from which STC may be separated and optionally transported, for example, to an STC hydrochlorination reactor or STC converter, and from which TCS/DCS may be directed to an optional in-process storage tank to provide reflux to the absorber column, and an optional front end TCS storage tank which may be used to store TCS (optionally in combination with other chlorosilanes) before delivery to the CVD reactor and/or the absorber column. In various embodiments of the disclosure, any one or more of these optional reactors/units etc. may be included within the statement of the present disclosure.

FIG. 1B is a schematic block diagram for a refrigerated condensing process and system that may optionally be used in conjunction with the process and system of FIG. 1A, FIG. 2, FIG. 3 and FIG. 4, including a first heat exchanger to transfer heat from the gas exiting the STC absorber column which has optionally traveled through a recycle gas compressor as shown in FIG. 1A, e.g., a hydrogen/TCS stream compressor and de-mister, and then optionally through a silica gel bed as also shown in FIG. 1A, a decanter, a second heat exchanger, a second decanter, where the second heat exchanger is in fluid communication with a refrigeration unit. This optional refrigeration process may be used to act upon the hydrogen/TCS recycle stream obtained from the hydrogen/TCS stream compressor and de-mister. In various embodiments of the disclosure, any one or more of these optional reactors/units etc. may be included within the statement of the disclosed process.

FIG. 2 is a schematic block diagram for an integrated system and process including a VGR system and process of the present disclosure, including the system and process illustrated in FIG. 1A and optionally in FIG. 1B, and further including a silica gel bed to treat the TCS/DCS stream exiting the TCS/STC distillation unit, with conduit for the treated stream to enter the hydrogen/TCS stream compressor and de-mister, and an optional condenser and an optional TCS/DCS tank located between the optional silica gel bed and the entry to the optional CVD reactor. In various embodiments of the disclosure, any one or more of these optional reactors/units etc. may be included within the statement of the disclosed process.

FIG. 3 is a schematic block diagram for an integrated system and process including a VGR system and process of the present disclosure, supplementing the system and process illustrated in FIG. 2 which incorporates elements as described previously for FIGS. 1A and 1B, and further including a DCS/TCS distillation unit to act on the TCS/DCS stream from the TCS/STC distillation unit, including conduits from the DCS/TCS distillation unit to transport the separated TCS to one or both of the in-process TCS tank and the front end TCS tank, and including conduits from the DCS/TCS distillation unit to transport separated DCS through an optional silica gel bed, and to one or both of the hydrogen/TCS stream compressor and de-mister and/or an optional condenser and optional DCS tank with an optional conduit to the CVD reactor. In various embodiments of the disclosure, any one or more of these optional reactors/units etc. may be included within the statement of the disclosed process.

FIG. 4 is a schematic block diagram for an integrated system and process including a VGR system and process of the present disclosure, supplementing the systems and processes illustrated in any one or more of FIGS. 1A, 1B, 2 and 3, and further incorporating a redistribution reactor, e.g., an A21 catalyzed redistribution reactor, to which purified DCS and purified STC may be transported and from which a mixture of TCS and STC may be received and then may optionally be transported to the TCS/STC distillation unit. In various embodiments of the disclosure, any one or more of these optional reactors/units etc. may be included within the statement of the disclosed process.

FIG. 5A is a schematic block diagram for an integrated system and process including a VGR system and process of the present disclosure, including an optional CVD reactor, an HCl converter reactor, an optional steam generator which functions as an optional heat recovery unit, an optional cooling water unit which functions as an optional vent gas cooling system, a VGR system including an absorber column, e.g., a TCS absorber column, an optional recycle gas compressor illustrated as a hydrogen/STC stream compressor and de-mister from which gas may exit by either or both of a hydrogen bleed going to, for example, an STC hydrochlorination reactor, or an optional silica gel bed and then an optional refrigerated condenser system as shown in FIG. 5B, a TCS/STC distillation unit for STC/TCS/DCS separation from which STC may be separated and optionally transported, for example, to an STC hydrochlorination reactor or STC converter or may be transported to the TCS absorber column, and from which TCS/DCS may be directed to a silica gel bed and/or condenser and/or TCS/DCS storage tank which may transport TCS/DCS to the CVD reactor. In various embodiments of the disclosure, any one or more of these optional reactors/units etc. may be included within the statement of the present process.

FIG. 5B is a schematic block diagram for an optional refrigerated condenser system and process for its use, including a first heat exchanger to transfer heat from the gas exiting the TCS absorber column which has optionally traveled through a recycle gas compressor as shown in FIG. 5A, for example, a hydrogen/STC stream compressor and de-mister, and then optionally through a silica gel bed as also shown in FIG. 5A, a decanter, a second heat exchanger, a second decanter, where the second heat exchanger is in fluid communication with a refrigeration unit. This optional refrigeration process may be used to act upon the hydrogen/STC recycle stream obtained from the hydrogen/STC stream compressor and de-mister. In various embodiments of the disclosure, any one or more of these optional reactors/units etc. may be included within the statement of the present process.

FIG. 6 is a schematic block diagram for an integrated system and process including a VGR system and process of the present disclosure, including the system and process illustrated in FIG. 5A and optionally in FIG. 5B, and further including DCS/TCS distillation unit to act upon the TCS/DCS stream from the TCS/STC distillation unit, including conduit from the DCS/TCS distillation unit to transport the separated TCS to the front end TCS tank, and including conduit from the DCS/TCS distillation unit to transport separated DCS through a silica gel bed, and to one or both of the hydrogen/STC stream compressor and de-mister and/or a condenser and DCS tank with an optional conduit to the CVD reactor. In various embodiments of the disclosure, any one or more of these optional reactors/units etc. may be included within the statement of the present process.

FIG. 7 is a schematic block diagram for an integrated system and process including a VGR system and process of the present disclosure, supplementing the system and processes illustrated in any one or more of FIGS. 5A, 5B and 6, and further incorporating a redistribution reactor, e.g., an A21 catalyzed redistribution reactor, to which purified DCS and purified STC may be transported and from which a mixture of TCS and STC may be received and then may optionally be transported to the TCS/STC distillation unit. In various embodiments of the disclosure, any one or more of these optional reactors/units etc. may be included within the statement of the present process.

FIG. 8A is a schematic block diagram for an integrated system and process including a VGR system and process of the present disclosure, including an optional CVD reactor from which polysilicon may be obtained, an HCl converter reactor, an optional steam generator which functions as an optional heat recovery unit, an optional cooling water unit which functions as an optional vent gas cooling system, a recycle gas compressor e.g., a hydrogen/TCS stream compressor and de-mister from which gas may exit by either or both of a hydrogen bleed going to, for example, an STC hydrochlorination reactor, or an optional silica gel bed and then a refrigerated condenser system as shown in FIG. 8B, a TCS/STC distillation unit for STC/TCS/DCS separation from which STC may be separated and optionally transported, for example, to an STC hydrochlorination reactor or STC converter, and from which TCS/DCS may be directed to an optional in-process storage tank before delivery to the CVD reactor. In various embodiments of the disclosure, any one or more of these optional reactors/units etc. may be included within the statement of the present process.

FIG. 8B is a schematic block diagram for an exemplary refrigerated condenser system and process of using the system. The refrigerated condenser system of FIG. 8B includes a first heat exchanger to transfer heat from the gas exiting the HCl converter reactor which has also traveled through a recycle gas compressor as shown in FIG. 8A, e.g., a hydrogen/TCS stream compressor and de-mister, and then optionally through a silica gel bed as also shown in FIG. 8A, a decanter, a second heat exchanger, a second decanter, where the second heat exchanger is in fluid communication with a refrigeration unit. This refrigerated condenser system may be used to act upon the hydrogen/TCS recycle stream obtained from the hydrogen/TCS stream compressor and de-mister. In various embodiments of the disclosure, any one or more of these optional reactors/units etc. may be included within the statement of the present process.

FIG. 9 is a schematic block diagram for an integrated system and process including a VGR system and process of the present disclosure, including the system and process illustrated in FIG. 8A and in FIG. 8B, and further including a silica gel bed to treat the TCS/DCS stream exiting the TCS/STC distillation unit, with conduit for the treated stream to enter the hydrogen/TCS stream compressor and de -mister, and an optional condenser and an optional TCS/DCS tank located between the optional silica gel bed and the entry to the optional CVD reactor. In various embodiments of the disclosure, any one or more of these optional reactors/units etc. may be included within the statement of the present process.

FIG. 10 is a schematic block diagram for an integrated system and process including a VGR system and process of the present disclosure, supplementing the system and process illustrated in FIG. 9 which incorporates elements as described previously for FIGS. 8A and 8B, and further including a DCS/TCS distillation unit to act on the TCS/DCS stream from the TCS/STC distillation unit, including conduits from the DCS/TCS distillation unit to transport the separated TCS to the front end TCS tank, and including conduits from the DCS/TCS distillation unit to transport separated DCS through an optional silica gel bed, and then to one or both of the hydrogen/TCS stream compressor and de-mister and/or an optional condenser and optional DCS tank with an optional conduit to the CVD reactor. In various embodiments of the disclosure, any one or more of these optional reactors/units etc. may be included within the statement of the present process.

FIG. 11 is a schematic block diagram for an integrated system and process including a VGR system and process of the present disclosure, supplementing the system and processes illustrated in any one or more of FIGS. 8A, 8B, 9 and 10, and further incorporating a redistribution reactor, e.g., an A21 catalyzed redistribution reactor, to which purified DCS and purified STC may be transported and from which a mixture of TCS and STC may be received and then may optionally be transported to the TCS/STC distillation unit. In various embodiments of the disclosure, any one or more of these optional reactors/units etc. may be included within the statement of the present process.

Corresponding reference numerals indicate corresponding parts throughout the drawings.

### DETAILED DESCRIPTION OF THE INVENTION

Provided herein are processes whereby a mixture of gases is separated into component parts or preferred compositions. Also provided are systems, e.g., a system to achieve a process and/or to prepare a feedstock or product stream. In addition, certain starting materials and product streams are provided.

In one embodiment, the process includes the following three steps, conducted in the stated order. First, a vent gas is directed through a reactor that contains a chlorination catalyst, wherein hydrogen chloride is reacted with DCS and/or TCS to yield TCS and/or STC, respectively. This first step will be referred to herein as the chlorination reaction or the chlorination step, and will take place in an HCl converter reactor. An exemplary HCl chlorinator reactor and its operation are disclosed in, for example, U.S. Pat. No. 5,401,872. This first step consumes HCl and thus generates a product stream substantially devoid of HCl. This first step may be conducted in a catalytic pipeline reactor as described in U.S. Pat. 5,401,872, the reactor being located in the vent gas line exiting the CVD reactor. The vent gas to the HCl converter reactor includes at least hydrogen chloride (HCl) and hydrochlorosilane.

As used herein, the term hydrochlorosilane refers to silicon containing molecules that have both hydrogen and chloride bonded to the silicon. Exemplary hydrochlorosilanes may be described by the formula HₐSiCl₄₋ₐ where a=1 to 3. Specific examples of hydrochlorosilanes are dichlorosilane (DCS) and trichlorosilane (TCS). The vent gas, which may also be referred as a starting gas, may also be described as including chlorosilanes, where the term chlorosilane refers to silicon-containing molecules that have at least one chloride atom bonded to the silicon. An example of a chlorosilane is silicon tetrachloride (a.k.a., tetrachlorosilane, and abbreviated as STC). A hydrochlorosilane is another example of a chlorosilane. The vent gas may optionally, and usually does, include hydrogen gas (H₂). While the vent gas is conveniently obtained as the off gas from a CVD reactor operating the Siemens reaction, other gas mixtures that contain HCl, chlorosilane(s) and hydrogen may be also be used in the process of the present disclosure.

Vent gases to be delivered to the HCl converter reactor may optionally be generated by any of several commercial processes for polysilicon production. One such process is a chemical vapor deposition (CVD) process used for forming solar grade, or semiconductor grade, or photovoltaic grade, silicon, which is commonly known as the Siemens process. As used herein, the term CVD reactor will refer to a reactor within which chemical vapor deposition occurs. A CVD reactor may be used to form polycrystalline silicon using trichlorosilane (SiHCl₃) or silane (SiH₄) as a component of the feedstock.

While various embodiments of the process and system of the present disclosure include this first step/reactor, other embodiments of the process and system omit this first step/reactor, or have this first step/reactor as an optional step. When present, the chlorination step provides that a gaseous vent stream comprising hydrogen chloride, typically in combination with hydrochlorosilane(s) such as TCS, and optionally in combination with other gases such as argon, nitrogen, hydrogen, is contacted with a chlorination catalyst, optionally at a super-ambient temperature. Such a gas vent stream is produced by many commercial processes, such as CVD processes for forming silicon grade or photovoltaic grade polysilicon. The chlorination step can be run at a temperature of up to about 700° C., or a temperature range of between about super-ambient temperature to about 700° C. The actual temperature selected will depend, in part, on the specific chlorination catalyst that is employed in the chlorination step. The catalyst may be a homogeneous or a heterogeneous catalyst. For example, when the chlorination catalyst is Pd/C (1-4 wt % Pd) a temperature up to about 300° C., or a temperature in the range of super-ambient to 300° C., or a temperature in the range of 50° C. to 200° C. may be employed. In general, 1-4 wt % Pd/C with a temperature in the range of 30° C. to about 250° C. are suitable process conditions for the chlorination reaction.

To effect quantitative recovery of the chloride ion of the hydrogen chloride from the gaseous vent stream, the molar ratio of silicon-bonded hydrogen to hydrogen chloride may be at least 1:1 in the process. Preferred is when the hydrochlorosilane(s) is present in molar excess in relation to the hydrogen chloride. The amount of molar excess of hydrochlorosilane in relation to the hydrogen chloride is not critical to the present process and can be those ratios which normally occur in such gaseous vent streams. For example, DCS can be added to vent gas stream in order to enrich the vent gas stream in hydrochlorosilane(s) and thereby achieve a molar excess of silicon-bonded hydrogen in relation to hydrogen chloride.

As mentioned previously, in a first step of the process, a chlorination catalyst is contacted with a gaseous vent stream comprising hydrogen chloride and hydrochlorosilanes. The chlorination catalyst for the process is selected from catalysts including metals such as palladium, platinum, rhodium, ruthenium, nickel, osmium, iridium. Preferred metals are palladium, platinum, ruthenium, rhodium, and nickel. The catalyst may comprise more than just the listed metal, and may be compounds that include the metal and other species, such as inorganic compounds, for example, metal salts and oxides, as well as organometallic compounds. Contact between the catalyst and the vent gas can be affected by standard methods known in the art. As mentioned previously, the chlorination catalyst may be a homogeneous or a heterogeneous catalyst. A suitable catalyst is any form of heterogeneous solid catalyst with morphology bringing high surface area per unit mass of catalyst. When a heterogeneous catalyst is selected, the gaseous vent stream can be contacted with catalysts in, a stirred-bed reactor, a fixed-bed reactor, or a fluidized-bed reactor, to name three examples.

Optionally, the metal or metal compound is supported on a solid substrate, i.e., any inert material of appropriate size and affinity for the metal or metal compound. Solid substrates for catalysts are well known in the art. Two examples are silica and carbon. For example, the solid support may be carbon with a surface area of about 1,000 M²/g. When the catalyst is placed on a solid support, the metal or metal compound may be present at concentrations that range from about 0.2 wt % to about 10 wt %, or from about 1 wt % to about 5 wt % (catalyst/support). Also optionally, the metal or metal compound includes chromium, where the chromium functions as a promoter and increases the efficiency of the catalysts mentioned above, e.g., a catalyst formed from nickel.

The chlorination reaction, whereby chlorine atoms are transferred from HCl to a hydrochlorosilane, is generally an exothermic reaction. Accordingly, some cooling process may be employed to maintain the chlorination reaction within the desired temperature range. In addition, the effluent gas from the chlorination reactor may be cooled prior to delivery to the absorber column or refrigerated condenser system.

The chlorination reaction may be run at a pressure of about 2-15 atmospheres, or a pressure of about 5-12 atmospheres, or a pressure of about 7-10 atmospheres. In general, as the operating pressure of the HCl converter reactor is increased, the size of the reactor may be decreased. Obviously, all other factors being equal, a smaller reactor is more advantageous in terms of the capital expense to build the reactor, compared to a larger reactor.

In a second step, the product stream from the chlorination reaction is separated into components comprising a hydrogen enriched stream and a chlorosilane enriched stream. This separation may be achieved by various means, where two exemplary means are described herein. In one approach, an absorber is used. In another approach, a refrigerated condenser system is used. These two approaches are not inconsistent with one another, so that in one embodiment of the disclosed process and system both an absorber and a refrigerated condenser system are present and used. By any of these or other suitable approaches, the hydrogen present in the product stream from the chlorination reaction is separated from the bulk of the chlorosilanes that are also present in the product stream from the chlorination reaction.

Accordingly, in one embodiment, in a second step, the product stream from the chlorination reaction is fed into an absorber, preferably into the bottom of an absorber, also referred to herein as an absorber column or an absorption column. In one embodiment, this product stream is cooled between exit from the chlorination reactor and entry into the absorber column. The product stream may be cooled to a desired temperature, for example, with a heat exchanger or a steam generator or in an air or water-cooled cooler. Noteworthy is that the product stream need not be cooled to a liquid phase, i.e., it may be maintained in the gas phase, or it may be cooled to provide a mixed gas-liquid phase where hydrogen is a component of the gas phase. When maintained in the gas phase, the temperature of this gas phase may be, in various embodiments, less than 200° C., or less than 100° C., or less than 75° C. or less than 50° C.

The construction and operation of absorbers is well known in the art. Briefly, an absorber achieves the removal of one or more selected components from a mixture of gases. In one embodiment, referred to as a liquid/gas absorber, a soluble gas (the “solute”) is scrubbed from a mixture of gases by means of a liquid, where the liquid may be referred to as the reflux liquid. Absorption columns or towers, also referred to as absorber columns or towers, or more simply as absorbers, are commonly used for gas absorption. Suitable design features for an absorber include: cylindrical column with a gas inlet and distributing space at the bottom; a liquid inlet and distributor at the top; gas and liquid outlets at the top and bottom respectively; column packing to ensure intimate contact between the liquid and the gas (column trays are an alternative option); and packing support to provide strength to the operational unit. The shell of the column may be constructed from metal, ceramic, glass or plastic materials, and may incorporate a corrosion-resistant interior lining. The column should be mounted truly vertically to help achieve uniform liquid distribution. The bed of packing rests on a support plate which desirably has at least 75% free area for the passage of the gas so as to offer as low a resistance as possible. The simplest support is a grid with relatively widely spaced bars on which a few layers of large raschig or partition rings are stacked. The column may include a gas injection plate designed to provide separate passageways for gas and liquid so that they need not compete for passage through the same opening. This is achieved by providing the gas inlets to the bed at a point above the level at which liquid leaves the bed. At the top of a packed bed a liquid distributor of suitable design provides for the uniform irrigation of the packing which is necessary for satisfactory operation. The packing should be selected so as to provide a large surface area for better contact between the gas and liquid. There is preferably an open structure in order to achieve a low resistance to gas flow. The packing should promote uniform liquid distribution on the packing material, and should promote uniform vapor gas flow across the column cross section. The packing may be random or structured. In operation, the inlet liquid, which may be a pure solvent or a dilute solution of solute in the solvent, is distributed over the packing uniformly by the use of distributors. The solute containing gas enters the distributing space below the packing and flows upwards through the spaces in the packing in the counter current to the flow of the liquid. The packing provides a large area of contact between the liquid and gas. The solute is absorbed by the fresh liquid (i.e., the reflux) entering the tower, and dilute gas leaves the top. The liquid reflux is enriched in solute as it flows down the tower, and concentrated liquid leaves the bottom of the tower through the liquid outlet. The absorber used in the present process and system may be a multi-stage absorber column, and in optional embodiments the column omits a reboiler and/or omits a condenser.

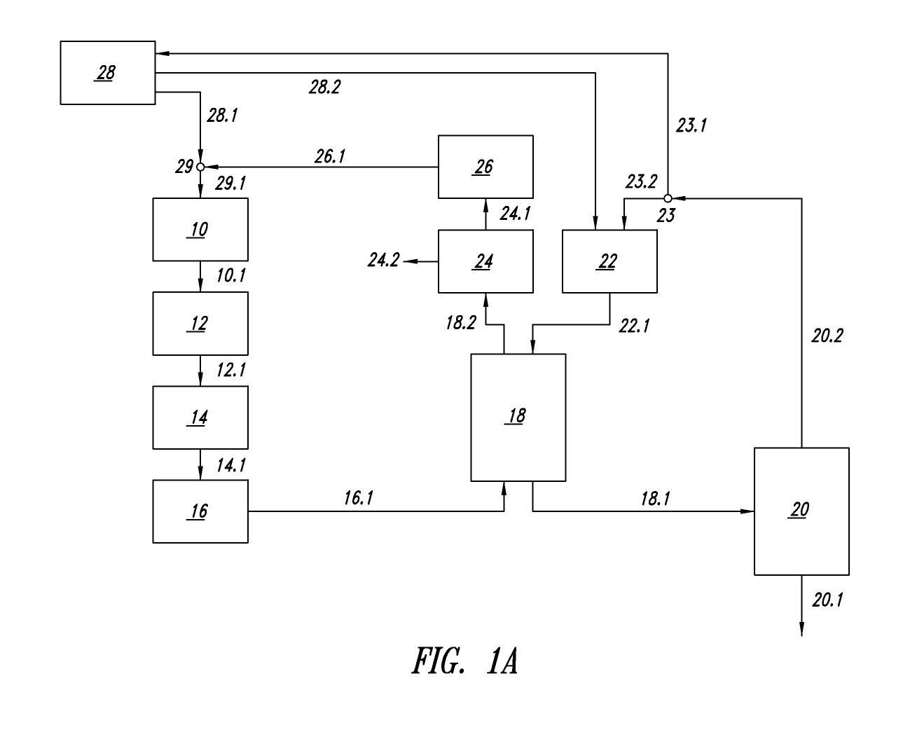

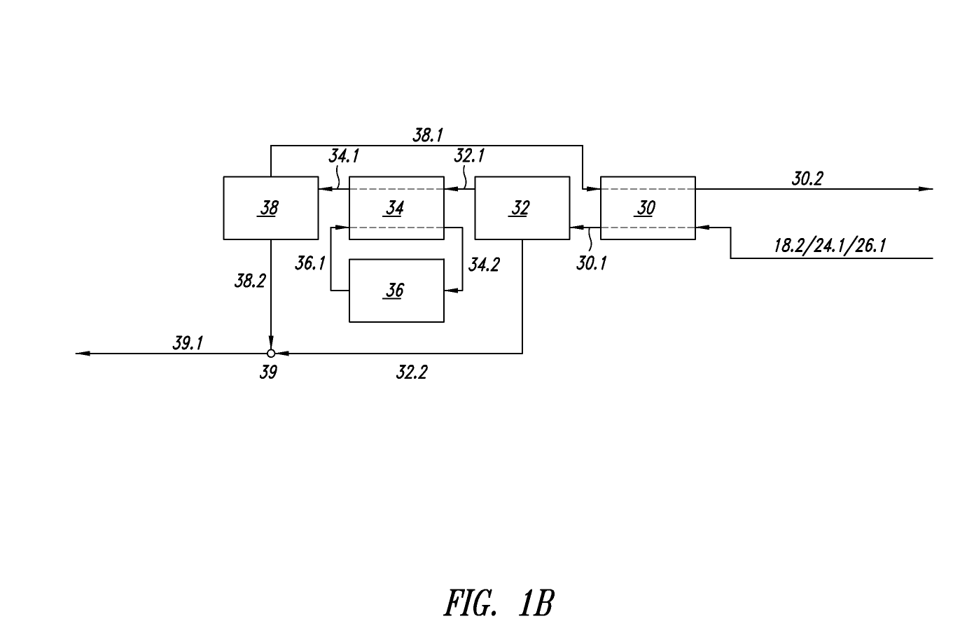

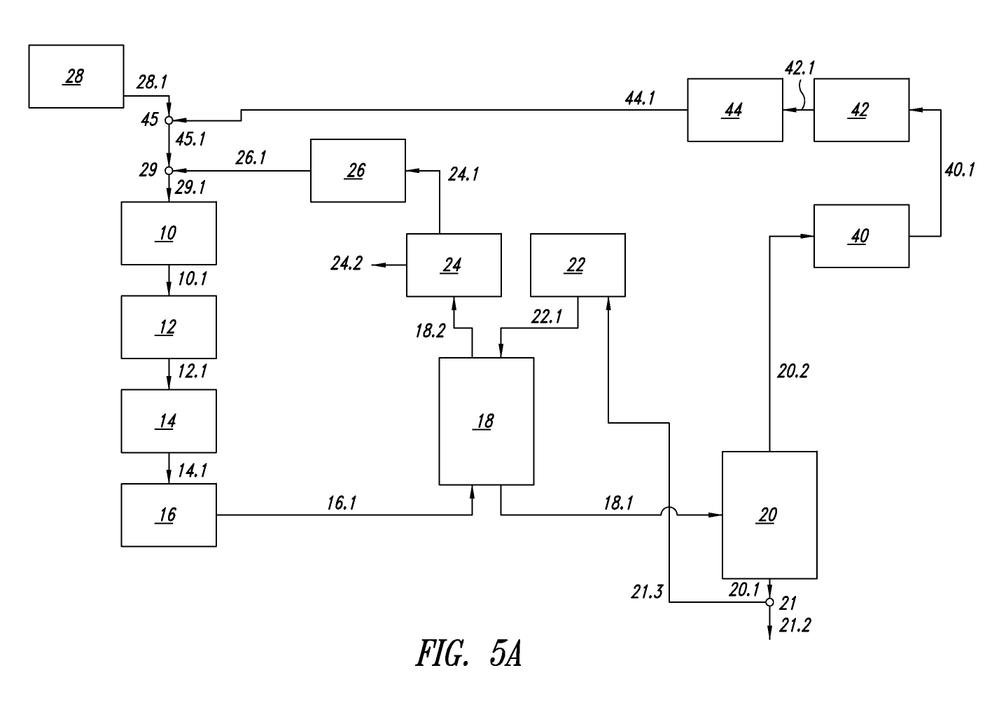

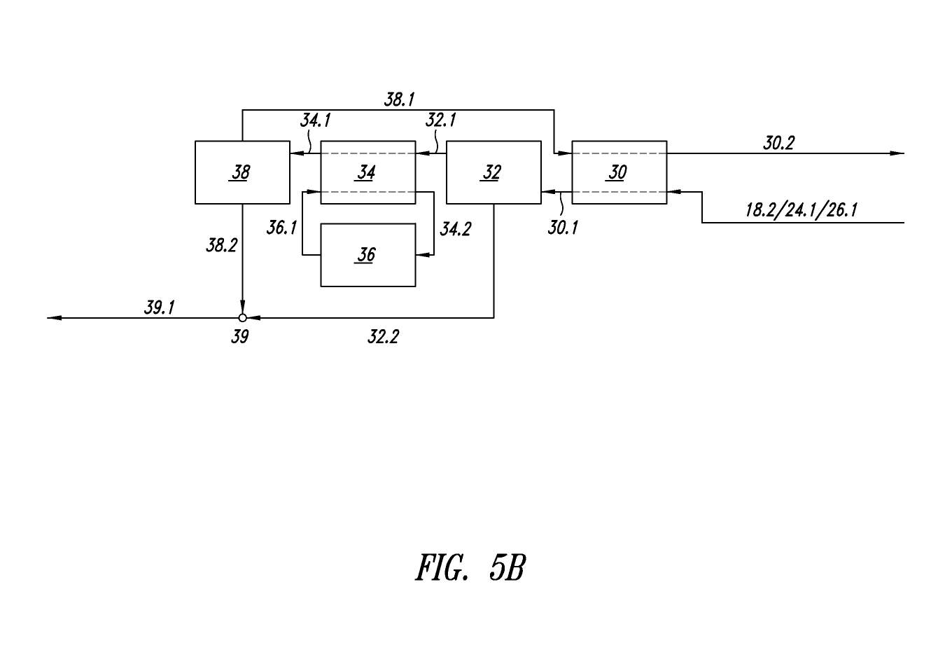

In addition to receiving product stream, the absorber column also receives liquid reflux, which is preferably fed onto the top tray of the absorber column. In various embodiments, the liquid reflux will comprise one or more reflux components, which may be primarily TCS (where exemplary embodiments of the process with TCS as a reflux component are shown in FIGS. 1A, 1B, 2, 3 and 4), primarily STC (where exemplary embodiments of the process with STC as a reflux component are shown in FIGS. 5A, 5B, 6 and 7), a mixture of TCS and DCS, or a mixture of TCS and STC. Optionally, a portion of the liquid reflux may be fed to a distributor stage located below the top tray of the column. The liquid reflux causes certain constituents of the product stream to be absorbed into the absorber liquid bottoms stream. Constituents so removed from the product stream include hydrochlorosilane, boron as BCl₃ and optionally STC, where hydrochlorosilane may be DCS and/or TCS.

In addition to generating a liquid bottoms stream, which may also be referred to herein as the second fraction, the absorber column will also provide or generate a gaseous hydrogen stream which contains one or more reflux components which were present in the liquid reflux. This gaseous hydrogen stream may also be referred to herein as the first fraction, i.e., the first fraction from the vent gas. For example, as shown in FIG. 1A, when TCS is a reflux component, the hydrogen stream will contain TCS. As shown in FIG. 5A, when STC is a reflux component, the hydrogen stream will contain STC. The hydrogen stream may also be referred to as the absorber product or the recycle gas or the recycle gas stream or the recycle hydrogen stream, since in one embodiment of the process, the hydrogen stream is recycled to the CVD reactor. The absorber column is preferably preceded or followed by a recycle gas compressor. In FIGS. 1-5, the recycle gas compressor is denoted as the hydrogen/TCS stream compressor and is shown downstream of the absorber column. Recycle gas pressure may be raised (e.g., from 6 bar gauge to 9 bar gauge) to provide sufficient additional pressure to compensate for pressure drop in recycle gas piping leading back to the CVD reactor, in an embodiment where the recycle gas stream is fed back to the CVD reactor, which is an option illustrated in the Figures. Such a compressor is a standard element of current industrial practice.

In a third step, referred to herein as the distillation step, a mixture of chlorosilanes is delivered to a distillation unit, which will be referred to herein as the TCS/STC distillation unit. For example, the liquid bottoms stream from the absorber, also referred to herein as the second fraction, is fed to a TCS/STC distillation unit. In the TCS/STC distillation unit, TCS, DCS, and BCl₃ are separated from the STC, or at least, a fraction enriched in STC is obtained separate from a fraction depleted in STC and therefore enriched in TCS, DCS and BCl₃. In the TCS/STC distillation unit, TCS/DCS are removed overhead, as a liquid or preferably as a vapor, and a bottoms stream is obtained comprised of STC.

Optionally, a portion of the overhead stream may be recycled back to the CVD reactor without further treatment (where it is mixed as a vapor with recycle hydrogen, and re-reacted in the CVD reactor), and a portion may be condensed, cooled to a desired temperature, and recycled back to the aforementioned absorber column for use as absorber reflux. Alternately, all or a portion of the overhead stream may be fed to a DCS/TCS distillation unit, where it is separated into an overhead stream substantially comprised of DCS and BCl₃, and a bottoms stream comprised of TCS. The overhead stream may be removed as a liquid, but it is preferably removed as a vapor.

The distillation step therefore creates at least two separate product streams: a third fraction highly enriched in TCS and DCS, and a fourth fraction highly enriched in STC. Depending in part on the system and process used to achieve separation of the first and second fractions, these third and fourth fractions may be utilized in the operation of a plant for the production of polysilicon. Provided below are some exemplary embodiments for utilizing the third and fourth fractions in a polysilicon plant, where the embodiments are provided with reference to the particular separation step (b).

In one embodiment the present disclosure provides a VGR process which comprises:
a) introducing a vent gas comprising hydrogen, hydrochlorosilane and hydrochloric acid to an HCl converter reactor comprising a metal catalyst, and contacting the vent gas with the metal catalyst to provide a product gas that is depleted in HCl, i.e., that comprises less hydrochloric acid than was present in the vent gas, and then removing the product gas from the reactor;
b) introducing the product gas from step a) into the bottom of an absorber column, introducing reflux comprising TCS into the top of the absorber column, withdrawing a second fraction as a liquid bottoms stream comprising TCS and STC from the bottom of the absorber column, and withdrawing a first fraction as a gas stream comprising hydrogen and one or both of TCS and STC from the top of the absorber; and
c) introducing the second fraction/liquid bottoms stream from step b) into a TCS/STC distillation unit, to generate a third fraction enriched in trichlorosilane and dichlorosilane, and a fourth fraction enriched in silicon tetrachloride.

In the aforesaid embodiment, any one or more of the following optional features and steps may further be used to describe the embodiment: the third fraction comprising TCS/DCS, optionally after being stored in a tank, e.g., tank (28) or tank (44), is combined with hydrogen to provide a feedstock for a CVD reactor wherein polysilicon is produced; the third fraction comprising TCS/DCS may be stored until it is needed in the plant, e.g., it may be stored in a tank (22) until it is used as reflux in an absorber column (18); the third fraction comprising TCS/DCS is contacted with a silica gel bed, e.g., (40), where the silica gel absorbs boron from the third fraction and a boron-depleted fifth fraction comprising TCS/DCS is produced; the fifth fraction comprising TCS/DCS is directed to a gas compressor (24) and may ultimately utilized as feedstock in a CVD reactor; the fifth fraction comprising TCS/DCS is combined with hydrogen to provide a feedstock to a CVD reactor, optionally after passing through a condenser (42) and/or a storage tank (44); the third fraction comprising TCS/DCS is separated into a sixth fraction enriched in TCS and a seventh fraction enriched in DCS; the sixth fraction comprising TCS may be directed to a storage tank (22) to be used as reflux for an absorber (18) or for any other purpose for which TCS may be needed in the plant; the sixth fraction comprising TCS, optionally after being stored in a tank, e.g., tank (28), is combined with hydrogen to provide a feedstock for a CVD reactor wherein polysilicon is produced; the seventh fraction comprising DCS, which may also contain boron and/or phosphorus, is sent to a waste treatment facility; the seventh fraction comprising DCS is contacted with silica gel, and boron is absorbed from the seventh fraction into the silica gel to provide an eighth fraction comprising DCS and little or no boron; the eighth fraction comprising DCS is directed to a gas compressor (24) and may ultimately utilized as feedstock in a CVD reactor; the eighth fraction comprising DCS is combined with hydrogen to provide a feedstock to a CVD reactor, optionally after passing through a condenser (42) and/or a storage tank (44); the eighth fraction comprising DCS, along with STC which may be provided, for example, by the fourth fraction, are directed to a redistribution reactor (50) to provide a ninth fraction comprising TCS and optionally minor amounts of DCS and/or STC; the fourth fraction comprising STC is directed to an STC converter; the fourth fraction comprising STC is directed to an STC hydrochlorinator; the fourth fraction comprising STC, along with DCS which may be provided, for example, by the 8th fraction, is directed to a redistribution reactor (50), to provide a ninth fraction comprising TCS and optionally minor amounts of DCS and/or STC.

In one embodiment the present disclosure provides a VGR process which comprises:
a) introducing a vent gas comprising hydrogen, hydrochlorosilane and hydrochloric acid to an HCl converter reactor comprising a metal catalyst, and contacting the vent gas with the metal catalyst to provide a product gas that is depleted in HCl, i.e., that comprises less hydrochloric acid than was present in the vent gas, and then removing the product gas from the reactor;
b) introducing the product gas from step a) into the bottom of an absorber column, introducing reflux comprising STC into the top of the absorber column, withdrawing a second fraction as a liquid bottoms stream comprising TCS and STC from the bottom of the absorber column, and withdrawing a first fraction as a gas stream comprising hydrogen and one or both of TCS and STC from the top of the absorber; and
c) introducing the second fraction/liquid bottoms stream from step b) into a TCS/STC distillation unit, to generate a third fraction enriched in trichlorosilane and dichlorosilane, and a fourth fraction enriched in silicon tetrachloride.

In the aforesaid embodiment, any one or more of the following optional features and steps may further be used to describe the embodiment: the third fraction comprising TCS/DCS, optionally after being stored in a tank, e.g., tank (28) or tank (44), is combined with hydrogen to provide a feedstock for a CVD reactor wherein polysilicon is produced; the third fraction comprising TCS/DCS is contacted with a silica gel bed, e.g., (40), where the silica gel absorbs boron from the third fraction and a boron-depleted fifth fraction comprising TCS/DCS is produced; the fifth fraction comprising TCS/DCS is directed to a gas compressor (24) and may ultimately be utilized as feedstock to a CVD reactor; the fifth fraction comprising TCS/DCS is combined with hydrogen to provide a feedstock to a CVD reactor, optionally after passing through a condenser (42) and/or a storage tank (44); the third fraction comprising TCS/DCS is separated into a sixth fraction enriched in TCS and a seventh fraction enriched in DCS; the sixth fraction comprising TCS, optionally after being stored in a tank, e.g., tank (28), is combined with hydrogen to provide a feedstock for a CVD reactor wherein polysilicon is produced; the seventh fraction comprising DCS, which may also contain boron and/or phosphorus, is sent to a waste treatment facility; the seventh fraction comprising DCS is contacted with silica gel, and boron is absorbed from the seventh fraction into the silica gel to provide an eighth fraction comprising DCS and little or no boron; the eighth fraction comprising DCS is directed to a gas compressor (24) and may ultimately utilized as feedstock in a CVD reactor; the eighth fraction comprising DCS is combined with hydrogen to provide a feedstock to a CVD reactor, optionally after passing through a condenser (42) and/or a storage tank (44); the eighth fraction comprising DCS, along with STC which may be provided, for example, by the fourth fraction, are directed to a redistribution reactor (50) to provide a ninth fraction comprising TCS and optionally minor amounts of DCS and/or STC; the fourth fraction comprising STC is directed to an STC converter; the fourth fraction comprising STC is directed to an STC hydrochlorinator; the fourth fraction comprising STC, along with DCS which may be provided, for example, by the 8^{th} fraction, is directed to a redistribution reactor (50), to provide a ninth fraction comprising TCS and optionally minor amounts of DCS and/or STC; the fourth fraction comprising STC may be directed to a storage tank, e.g., tank (22), for storage until it is needed in the plant, for example, it may be needed as reflux for absorber (18).

In one embodiment the present disclosure provides a VGR process which comprises:
a) introducing a vent gas comprising hydrogen, hydrochlorosilane and hydrochloric acid to an HCl converter reactor comprising a metal catalyst, and contacting the vent gas with the metal catalyst to provide a product gas that is depleted in HCl, i.e., that comprises less hydrochloric acid than was present in the vent gas, and then removing the product gas from the reactor;
b) introducing the product gas into a refrigerated condenser system, to generate a first fraction enriched in hydrogen and a second fraction enriched in silicon tetrachloride, trichlorosilane and dichlorosilane.
c) introducing the second fraction from step b) into a TCS/STC distillation unit, to generate a third fraction enriched in trichlorosilane and dichlorosilane, and a fourth fraction enriched in silicon tetrachloride.

In the aforesaid embodiment, any one or more of the following optional features and steps may further be used to describe the embodiment: the third fraction comprising TCS/DCS, optionally after being stored in a tank, e.g., tank (44), is combined with hydrogen to provide a feedstock for a CVD reactor wherein polysilicon is produced; the third fraction comprising TCS/DCS is contacted with a silica gel bed, e.g., (40), where the silica gel absorbs boron from the third fraction and a boron-depleted fifth fraction comprising TCS/DCS is produced; the fifth fraction comprising TCS/DCS is directed to a gas compressor (24) and may ultimately utilized as feedstock in a CVD reactor; the fifth fraction comprising TCS/DCS is combined with hydrogen to provide a feedstock to a CVD reactor, optionally after passing through a condenser (42) and/or a storage tank (44); the third fraction comprising TCS/DCS is separated into a sixth fraction enriched in TCS and a seventh fraction enriched in DCS; the sixth fraction comprising TCS, optionally after being stored in a tank, e.g., tank (28), is combined with hydrogen to provide a feedstock for a CVD reactor wherein polysilicon is produced; the seventh fraction comprising DCS, which may also contain boron and/or phosphorus, is sent to a waste treatment facility; the seventh fraction comprising DCS is contacted with silica gel, and boron is absorbed from the seventh fraction into the silica gel to provide an eighth fraction comprising DCS and little or no boron; the eighth fraction comprising DCS is directed to a gas compressor (24) and may ultimately utilized as feedstock in a CVD reactor; the eighth fraction comprising DCS is combined with hydrogen to provide a feedstock to a CVD reactor, optionally after passing through a condenser (42) and/or a storage tank (44); the eighth fraction comprising DCS, along with STC which may be provided, for example, by the fourth fraction, are directed to a redistribution reactor (50) to provide a ninth fraction comprising TCS and optionally minor amounts of DCS and/or STC; the fourth fraction comprising STC is directed to an STC converter; the fourth fraction comprising STC is directed to an STC hydrochlorinator; the fourth fraction comprising STC, along with DCS which may be provided, for example, by the 8^{th} fraction, is directed to a redistribution reactor (50), to provide a ninth fraction comprising TCS and optionally minor amounts of DCS and/or STC.

The process described herein may include optional steps. In one optional step, the DCS/TCS-containing product stream may be added to the hydrogen recycle stream for reaction in CVD reactor operating the Siemens' process. In another optional embodiment, the DCS/TCS-containing product stream may be condensed and added to the Siemens' CVD reactor feed according to a certain recipe, the purpose of which may comprise increasing the CVD decomposition rate in the CVD reactor. In another optional embodiment, the DCS-containing product stream as a vapor stream from the distillation step may be fed, in combination with a stoichiometric excess of STC vapor, to a redistribution reactor where it is substantially converted to TCS for recycle to the CVD reactor. In yet another optional embodiment, the DCS-containing product stream from the distillation step may be condensed and fed as a liquid, in combination with a stoichiometric excess of STC liquid, to a redistribution reactor where it is substantially converted to TCS for recycle to the CVD reactor. A distillation step may be included whereby DCS is separated from TCS. A silica gel bed may be added for treatment of a DCS-containing vapor stream to remove boron species such as BCl₃. For instance, a silica gel bed may be placed in contact with the main hydrogen recycle vapor stream to remove boron species such as BCl₃, and/or the silica gel bed may be placed in contact with a DCS-enriched stream that contains boron species such as BCl₃. In the later case, the resulting boron-depleted DCS-enriched stream may be added to the hydrogen recycle stream. One or more of these optional steps, as will become clear, offer substantially improved operational utility, and theft inclusion in the process system is highly desirable.

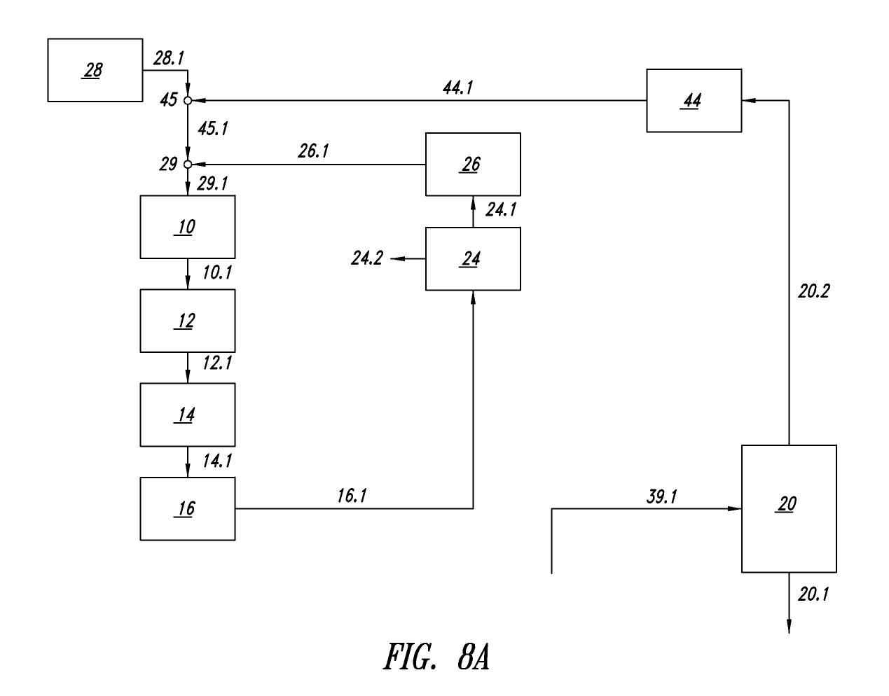

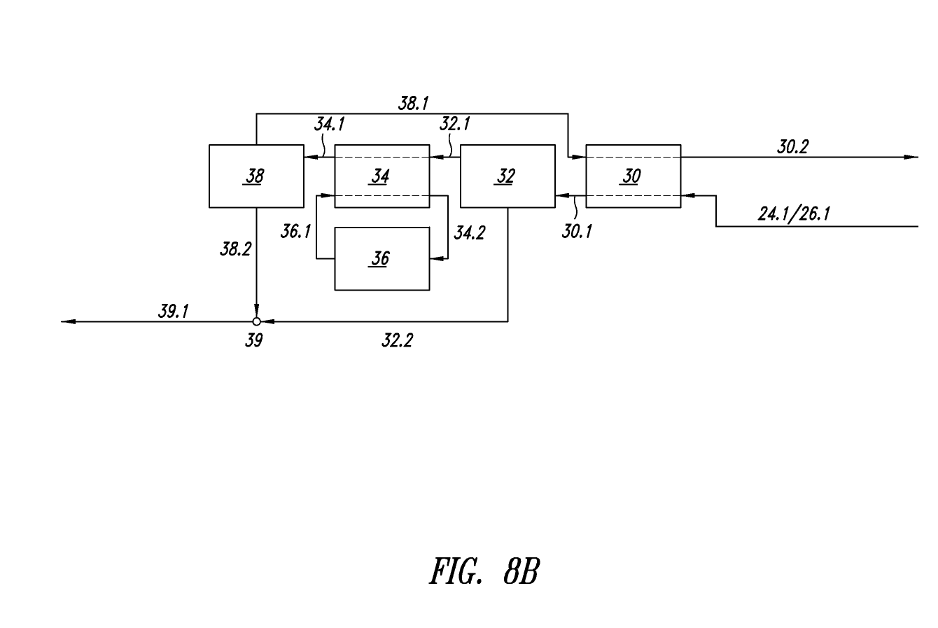

Also optionally, when TCS is used as a reflux component of the reflux delivered into the absorber, then H₂ saturated with TCS (i.e., the gas stream comprising hydrogen and TCS obtained from the top of the absorber) may go straight to the CVD reactor, or alternately it may go to a refrigerated condenser system to condense out substantially all of the TCS from the H₂ recycle. Likewise, when STC is used as a reflux component of the reflux delivered into the absorber, then the resulting H₂ saturated with STC (i.e., the gas stream comprising hydrogen and STC obtained from the top of the absorber) may be directed into a refrigerated condenser system in order to separate H₂ from STC, and then optionally direct the purified H₂ into a CVD reactor. A suitable refrigerated condenser system is illustrated and described herein with reference to FIG. 1A, FIG. 5A and FIG. 8A. Other configurations of a refrigerated condenser system may be employed in the systems and processes of the present disclosure, so long as refrigeration and gas compression are utilized to separate a mixture comprising hydrogen and chlorosilanes into at least two streams, one stream comprising primarily hydrogen and the other stream comprising primarily chlorosilanes.

Because the amount of STC in the H₂ recycle at 35° C. is approximately equal to the amount of STC in the vent gas leaving the CVD reactor, if the refrigerated condenser system is omitted, then an excessive amount of STC would be present in the H₂ recycle that is directed back to the CVD reactor. Because STC is a by-product of the CVD reaction, utilizing a H₂ feed with an excessive amount of STC in it would have a deleterious effect on the decomposition reaction. When it is desired to remove chlorosilane from the gas stream comprising hydrogen and chlorosilane (TCS and/or STC) obtained from the top of the absorber, it is much easier to condense out STC than TCS due to the higher boiling point of STC (57° C. at atmospheric pressure) relative to that of TCS (31° C. at atmospheric pressure). Accordingly, when it is desired to obtain a purified H₂ stream from the gas stream comprising H₂ and TCS obtained from the top of the absorber, it is advantageous to use STC as a reflux component of the reflux delivered into the absorber in conjunction with a subsequent refrigerated condenser system. The purification of TCS from the gas stream comprising H₂ and TCS obtained from the top of the absorber is not a necessary step of the present process.

As mentioned several times herein, the present process may operate at super ambient temperature(s). As used herein, the term super ambient temperature(s) refers to temperatures that are greater than the ambient temperature, where ambient temperature refers to the temperature that surrounds the plant or facility that is operating the present process. In various embodiments, the super ambient temperature is greater than 25° C., or greater than 30° C., or greater than 35° C., or greater than 40° C., or greater than 45° C., or greater than 50° C., or greater than 55° C., or greater than 60° C. Unlike current industrial practices for separating an off gas mixture from the Siemens CVD process, the operation of which has a high electrical utility load, no refrigeration is necessarily used in performing the three steps referred to herein as chlorination, absorption and distillation.

While refrigeration is not always required in performing the chlorination, absorption and distillation processes described herein, refrigeration may optionally be included as a part of the disclosed process, as illustrated in FIGS. 1A-7. Sometimes, refrigeration is necessarily included the processes and systems of the present disclosure, see, for example, the embodiments illustrated in FIGS. 8A, 9, 10, and 11. When refrigeration is included in the present process or system, that refrigeration does not, in one embodiment of the present process, cool a reactant stream or product stream to a temperature that is less than ambient temperature, i.e., to a temperature that is less than the temperature that surround the plant or facility that is operating the process. However, in still another embodiment, refrigeration may be used to cool a product or reactant stream to a temperature below ambient temperature, e.g., to a temperature below 25° C., or below 20° C., or below 15° C., or below 10° C., or below 5° C., or below 0° C.

The industry currently separates and recovers materials in a VGR system comprising many costly unit operations, where these unit operations include:
Heat exchange with cooling tower water to cool hot CVD vent gases to ambient temperature range;
Multiple heat exchangers employing several refrigerated cooling mediums (e.g., minus 5° C. to minus 30° C.) to create a sub-cooled CVD vent gas stream from which much of the chlorosilane content has been removed;
Multiple heat exchangers employing extremely cold refrigerated cooling mediums (e.g., minus 30° C. to minus 50° C. to minus 70° C.) to remove substantially all chlorosilane content from the hydrogen gas stream;
Absorption step where HCl in the extremely cold vent gas stream is absorbed out of the hydrogen stream into an extremely cold liquid comprising mixed chlorosilanes.
Heat interchange to reduce cooling costs;
Distillation step where the extremely cold chlorosilane absorbent stream is separated from absorbed HCl, yielding a pure HCl stream and a stream containing TCS, DCS and STC.
Refrigerated condensing step where HCl gas, having been separated from chlorosilane absorbent, is condensed into a liquid state and stored as a refrigerated liquid
Distillation step where mixed chlorosilanes, having been separated from absorbed HCl, are separated into an STC stream and a stream comprising DCS and TCS; and
Optional distillation step where a stream comprising DCS and TCS is separated into a stream containing DCS and a stream containing TCS.
   As is made clear by the multitude of steps required, the current practiced vent gas treatment process is capital intensive and costly to operate.

Disadvantages of the currently practiced vent gas treatment process, compared to the process of the present disclosure, include:
High refrigerant load, with concomitant high electricity cost;
High cooling water load, with concomitant high electricity cost and water usage;
Complex and hard to control process operations;
4× to 10× higher boron in polysilicon product; and
2× to 7× higher TCS evaporation load in the CVD area, resulting in significantly higher heating medium duty load.

As already discussed, the process and system described herein may include optional embodiments. In one optional embodiment, the process includes a purification step, wherein a starting mixture or a product stream is contacted in vapor form with a silica gel bed. The silica gel bed may be included in a statement providing a system of the present disclosure. In the purification step, boron species are removed from the starting mixture or any of the product streams. This is highly advantageous. In the process most commonly employed in existing commercial operations, boron in refined TCS makeup to the CVD reaction area is recycled, together with TCS and DCS recovered from the CVD vent gas, until all such boron is incorporated into the polysilicon product—in other words, the only purge point for boron from the CVD and the integrated VGR system is in the polysilicon product. The present process provide a means of purging boron separate from its co-deposition with polysilicon, with the advantageous result that higher purity polysilicon may be produced.

Silica gel beds can, when properly conditioned and operated, remove boron, including boron as BCl₃, from chlorosilane streams, including from a DCS-containing vapor stream. Such removal may be substantially quantitative. When the vent gas is generated by the Siemens CVD process operating under normal conditions, the distillation product stream that includes DCS will not contain very much boron. Due to the very low boron content in the DCS stream, and the relatively high capacity of the silica gel bed for boron retention, the silica gel bed can have a life time measured in years, even as many as ten years. It is preferred to create a vent gas stream component that is enriched in boron, since passing a boron-enriched vent gas stream component over a silica gel bed will be more effective at removing greater amounts of boron, e.g., boron trichloride. This effect is based on the fact that a silica gel bed cannot decrease the boron content in the effluent below a certain amount—this amount being the breakthrough concentration level. If the feed to the silica bed has a very low concentration of boron, a concentration near the breakthrough concentration, then the boron removal efficiency will be low. However, if the concentration of boron in the feed to the silica gel bed is increased, according to the methods taught herein, then the removal efficiency will be proportionately increased. The silica gel bed will also remove a certain amount of phosphorus, if present as a low boiling species, from the product stream containing DCS. In any event, silica gel beds may be reconditioned or regenerated for continued use.

In various preferred embodiments, the DCS-containing vapor leaving the silica gel bed may be added to the hydrogen recycle stream for reaction in the CVD reactor, or it may be condensed and added to the CVD reactor feed according to a certain recipe, the purpose of which may comprise increasing the CVD decomposition rate in the CVD reactor. Alternately, the DCS-containing vapor leaving the silica gel bed may be fed, in combination with a stoichiometric excess of STC vapor, to a redistribution reactor where it is substantially converted to TCS for recycle to the CVD reactor. Alternately, the DCS-containing vapor leaving the silica gel bed may be condensed and fed as a liquid, in combination with a stoichiometric excess of STC liquid, to a redistribution reactor where it is substantially converted to TCS for recycle to the CVD reactor. The chemistry that take place within the redistribution reactor is: DCS+STC→2TCS.

A redistribution reactor is an optional component of each of the systems and processes described herein. In the redistribution reactor, two separate compositions may be directed into the reactor. One composition primarily comprises dichlorosilane, i.e., is a composition that is at least 50 wt % dichlorosilane, while the other composition primarily comprises silicon tetrachloride, i.e., is a composition that is at least 50 wt % silicon tetrachloride. Alternatively, a single composition is directed into the redistribution reactor, where this single composition contains both dichlorosilane and silicon tetrachloride. The redistribution reactor is operated under redistribution conditions, so that a redistribution reaction occurs between the dichlorosilane and the silicon tetrachloride, and trichlorosilane is thereby produced. A catalyst may be present in the redistribution reactor, e.g., a combination of tertiary amine and tertiary amine salt at disclosed in, e.g., U.S. Pat. No. 4,610,858, As disclosed in U.S. Pat. No. 4,610,858, the combination of tertiary amine and tertiary amine is salt is used to allow for a disproportionation reaction, which is an equilibrium reaction whereby TCS may be converted to silane (SiH₄) and STC. The redistribution reaction of the present disclosure may utilize the same catalyst and operating conditions of temperature and pressure as disclosed in U.S. Pat. No. 4,610,858, however unlike the reaction disclosed in U.S. Pat. No. 4,610,858, the present disclosure introduces STC and DCS into the reactor, and recovers TCS as the product. A fixed bed or fluid bed reactor may be employed in the redistribution reactor. A redistribution reactor may be included in any of the systems and processes described herein which generate a 7^{th} fraction which comprises DCS, and accordingly which include a DCS/TCS distillation unit.

As another example of including a purification step in the process described herein, the hydrogen recycle vapor stream, i.e., the first fraction, may be passed through a silica gel bed. This first fraction, which may be generated from the absorber column or the refrigerated condenser system, may be fed as a vapor to a silica gel bed to remove boron, including boron species comprising BCl₃. Due to the dilution of this stream by the large amount of hydrogen in the recycle, such removal, while constructive, may not be quantitative. Due to the very low boron content in the recycle gas stream, and the relatively high capacity of the silica gel bed for boron retention, the silica gel bed can have a life time measured in years, even as many as ten years. The silica gel bed will also remove a certain amount of phosphorus, if present as a low boiling species, from the recycle gas stream.

As a further example of including a purification step in the process described herein, the TCS-containing product stream from the distillation step, i.e., the third fraction, may be fed as a vapor to a silica gel bed to remove boron, including boron species comprising BCl₃. While this approach has the advantage of not necessarily requiring the separation of TCS from DCS, it suffers from the fact that the presence of TCS will tend to dilute the boron concentration of the gas stream, relative to a gas stream comprising boron and primarily DCS with a minor amount of TCS. When boron species are present at a relatively lower concentration in the feed to the silica gel bed absorber, the efficiency of their removal (the percentage of boron species that is removed from the gas stream) will be reduced.

Achieving the removal or reduction of boron content in the feedstock to a CVD reactor by the present process may utilize a DCS/TCS distillation unit to subject the vent gas or a fraction thereof to fractionation based on the boiling points of the components, as discussed above. The boiling points of DCS and BCl₃ are close to one another, and thus a fraction that is enriched in DCS may also be enriched in BCl₃, if the fraction includes a boiling point range that captures both materials. Such a fraction, enriched in both DCS and BCl₃, may be passed into a silica gel bed as described above, to provide an effluent that is reduced in, or has essentially no boron, but has a high content of DCS. This boron-free or low boron content DCS may be included in the feedstock that goes into the CVD reactor, as described above. Alternatively, a fraction enriched in both DCS and BCl₃ may be obtained and then discarded or sent to a waste treatment facility. While this approach is wasteful of the DCS, and thus effectively reduces the yield of polysilicon from chlorosilane feedstocks, this approach does have the advantage of separating BCl₃ from other components of the vent gas, where one or more of those other components may then be recycled to the CVD reactor, to provide a feedstock with relatively low boron content, i.e., a boron content that is lower than would be the case if the DCS in non-purified form were allowed to be recycled to the CVD reactor. This approach also has the advantage that there is no need to further purify the DCS stream by, e.g., passing it across or through silica gel. Thus, the costs associated with the silica gel are avoided.

As mentioned above, the boiling points of DCS and BCl₃ are close to one another, and thus a distillation fraction that is enriched in DCS may also be enriched in BCl₃, if the fraction includes a boiling point range that captures both materials. In one embodiment of the present process, the distillation is performed in such a manner that the DCS and the BCl₃ are separated from one another by putting them into different fractions, or at least creating two fractions that are enriched in DCS and BCl₃, respectively. The boiling point of DCS is 8.4° C. when the boiling point of BCl₃ is 12.6° C., each at atmospheric pressure. Thus, the DCS will boil at a lower temperature than BCl₃, and may be separated from BCl₃ by careful distillative fractionation. This approach has the advantage of eliminating the need for a silica gel source to absorb BCl₃ from DCS. However, because the boiling points of the two materials are rather close, the distillative fractionation must be performed carefully, and that necessity will create capital expenses and operating costs not otherwise present in the present process.

A purification step is advantageously included in the present process, since currently practiced VGR processes do not provide a means to reduce or eliminate boron contamination from resulting product streams. Thus, when these product streams are introduced into a Siemens' CVD reactor, the boron contamination enters the reactor with the desired feedstock/s), and some of that boron will deposit in the polysilicon product. In other words, when these product streams are recycled into a Siemens CVD reactor, the boron contaminants enter the reactor and deposit, to some extent, in the polysilicon product. In consequence, the polysilicon product has a diminished purity compared to what would be created with a boron-free feedstock. In the currently practiced commercial Siemens' CVD process, 100% of boron fed to the CVD reactor from the refined TCS plant, as species comprising BCl₃, ends up in the polysilicon product. In current industrial practice:
Only 5% to 20% of BCl₃ fed to the CVD reactor is decomposed per pass through the CVD reactor. Decomposed BCl₃ ends up as boron in polysilicon.
Unconverted BCl₃ goes to the HCl absorber, where it is absorbed into the absorber bottoms stream. Noteworthy is that the boiling point for BCl₃ is 4° C. higher than the boiling point for DCS, which is also absorbed into the absorber bottoms stream. Accordingly, by utilizing differences in boiling points (vapour pressure) to separate components of the vent gas stream as taught by the present disclosure, a fraction enriched in DCS will also be enriched in BCl₃. As described elsewhere herein, contacting such a fraction enriched in DCS and BCl₃ with a silica gel bed according to the present disclosure will remove some or all of the BCl₃ from the fraction, providing a DCS fraction with a relatively reduced boron concentration.
The absorber bottoms stream is fed to the HCl recovery column. HCl is removed overhead, while DCS, BCl₃, TCS, and STC exit the bottom of the column.
DCS and BCl₃, which have almost the same boiling point, and the heavier boiling TCS are removed overhead in the TCS/STC distillation unit and are recycled back to the CVD reactor.
BCl₃ builds up in the recycle TCS stream to the CVD reactor, until its boron component is completely incorporated into the polysilicon product.
   By way of contrast, compared to current industrial practice, in one embodiment of the present process there is provided an innovative means for the concentration and efficient removal of substantially all boron as species comprising BCl₃.

While in one embodiment all of the steps in a process as described herein are operated at super-ambient temperature, in another embodiment there is one place in the process where cooling is used so that the reactants and/or products are at sub-ambient temperature. As one example, it may be advantageous to refrigerate the H₂ recycle stream, i.e., the first fraction, that exits the absorber column or the refrigerated condenser system, in order to liquefy the chlorosilanes while leaving the H₂ as a gas, and then separating the gas from the liquid to provide a purified hydrogen gas stream. Subsequently, in a further optional embodiment, that purified hydrogen gas stream may be run through a carbon absorption bed to produce a highly pure H₂ stream from which virtually all chlorosilane has been removed. The use of a carbon bed may remove virtually all of the chlorosilanes from the recycle H₂ stream, and may also remove trace impurities such as methane and methylchlorosilanes. Methane and/or methylchlorosilanes, if present, can lead to increased carbon content in the polysilicon made in the CVD reactor, thereby reducing the polysilicon's fitness for use. Consequently, it is desirable in some instance to refrigerate the recycle H₂ stream in order to separate chlorosilanes from the hydrogen, and then polish the hydrogen in a carbon absorption bed, in order to achieve a high purity hydrogen stream.

The presence of boron, phosphorous and carbon contaminants in polysilicon reduces the fitness of that polysilicon for commercial use, for instance, use in the manufacture of photovoltaic cells and semiconductors. The present process includes optional steps and operational units that can be used to reduce boron, phosphorous and/or carbon in the feedstock entering a CVD reactor that is used for polysilicon production. For example, the present process and system may include a silica gel bed that may be used to absorb boron and phosphorous species from a gas stream. In addition, or alternatively, the present process and system may include a carbon bed, e.g., activated charcoal, which may be used to absorb carbon species from a gas stream. By these means, polysilicon with lowered levels of boron, phosphorous and/or carbon species may be produced.

In the vent gas treatment process utilized in most commercial plants in current operation, virtually all chlorosilane, including TCS, is removed from the hydrogen gas recycle stream to the CVD reactor. Therefore, as a percentage of the total amount of TCS required to be fed to the CVD reactor, the amount of TCS, as vapor, in the hydrogen recycle stream is less than 5% to 10%. This leaves 90% to 95% or more of the TCS to come from other source(s). Most commonly, that other source is a TCS storage tank which contains highly pure TCS stored in liquid form. This TCS must be vaporized before it is fed to the CVD reactor. The energy load required for such vaporization is significant and comprises a significant portion of the total energy required to operate the plant. In one embodiment, the present process reduces the energy requirement for such vaporization by utilizing a hydrogen recycle stream containing TCS in the vapor phase. This optional process utilizes a hydrogen recycle stream comprising a TCS:hydrogen molar ratio of, in various embodiments, at least 5:95, or at least 10:90, or at least 20:80, or at least 30:70, or at least 40:60. Therefore, when a hydrogen recycle stream prepared as described herein, which contains TCS as described herein, is used as a partial supply of TCS to a CVD reactor, relatively less TCS needs to be vaporized from the TCS storage facility to achieve a target level of TCS in the feedstock to the CVD reactor. In essence, by increasing the concentration of TCS in the gas stream leaving the VGR process, and maintaining that TCS at super-ambient temperature, that TCS is available to the CVD reactor without need to vaporize an equivalent amount of the liquid form of TCS to the vapor state, i.e., the TCS exists in a pre-vaporized form. The term “TCS pre-vaporization” refers to the practice taught herein whereby the hydrogen recycle stream leaving the VGR area contains a significant amount of the total amount of TCS required to be fed to the CVD reactor. The term “% TCS pre-vaporization” refers to the percentage of the TCS that must be fed to the CVD reactor as vapor that is present as vapor in the hydrogen recycle stream, leaving the VGR area, going to the CVD reactor.

The processes and systems as provided herein may be further illustrated and described by reference to the appended FIGS. 1A-11. In these Figures, various specific and optional embodiments including the VGR system of the present disclosure are illustrated, and are shown as they may, optionally, be integrated into a plant for the manufacture of polysilicon. Like elements in the various Figures are denoted by like reference numerals for consistency.

FIG. 1A is a schematic block diagram which illustrates an integration of systems and processes that incorporate the VGR system and process of the present disclosure into a polysilicon manufacturing plan. The integrated system and process includes an optional CVD reactor 10 with an exit conduit 10.1, an optional HCl converter reactor 12 with an exit conduit 12.1, optional heat recovery equipment 14 with an exit conduit 14.1, e.g., a steam generator, and an optional vent gas cooling system 16 with an exit conduit 16.1, e.g., cooling water. FIG. 1A also shows the VGR system of the present disclosure including an absorber column 18 with exit conduits 18.1 and 18.2, e.g., an STC absorber column. The integrated system and process of FIG. 1A also includes an optional recycle gas compressor 24 with exit conduit 24.1 and optional exit conduit 24.2, e.g., a hydrogen/TCS stream compressor and de-mister from which fluid may exit by either or both of exit conduit 24.2 which provides for a hydrogen bleed going to, for example, an STC hydrochlorination reactor (not shown), or exit conduit 24.1 which provides for fluid delivery to an optional silica gel bed 26 with exit conduit 26.1. The exit conduit 26.1, when present, optionally leads to the CVD reactor 10, optionally first passing through a refrigerated condenser system as shown in FIG. 1B. The contents of exit conduit 26.1 may be combined with the contents of exit conduit 28.1 at a valve 29 as shown in FIG. 1A to as to provide an exit conduit 29.1 which delivers a combination of hydrogen and TCS to a reactor 10. The valve 29 is optional: either or both of conduits 28.1 and 26.1 may lead directly to CVD reactor 10 without passing through optional valve 29. The integrated system and process of FIG. 1A includes a TCS/STC distillation unit 20 with exit conduits 20.1 and 20.2, for STC/TCS/DCS separation so as to provide STC separated from other components. A product stream comprising only or primarily STC, which may be referred to herein as the first fraction, may be transported from the TCS/STC distillation unit 20 via exit conduit 20.1 to, for example, an STC hydrochlorination reactor (not shown) or an STC converter (not shown). A product stream comprising only or primarily TCS and/or DCS, which may be referred to herein as the second fraction, may be transported from the TCS/STC distillation unit 20 via exit conduit 20.2 to an optional in-process storage tank 22 having exit conduit 22.1, where the exit conduit 22.1 may provide reflux to the absorber column 18. TCS/DCS delivery from TCS/STC distillation unit 20 may also or alternatively be by way of exit conduit 20.2 to a tank 28 for storage of TCS. Optionally, and as shown in FIG. 1A, exit conduit 20.2 may split at a valve 23 so as to provide two fluid streams, one fluid stream traveling through conduit 23.1 to the tank 28 and the other fluid stream traveling through conduit 23.2 to tank 22. The valve 23 is optional, where conduit 20.2 may lead directly to either tank 22 or tank 28 without contact with valve 23. Tank 28 may be used to store TCS and/or DCS as a reservoir to be drawn upon when needed to supply feedstock to the CVD reactor 10 via exit conduit 28.1, optionally passing through valve 29 and then exit conduit 29.1 before arriving at reactor 10. The tank 28 may also, optionally, have exit conduit 28.2 which leads to tank 22, so that tank 28 may supply TCS and/or DCS to the tank 28 which can, in turn, supply TCS and/or DCS reflux to the absorber column 18. In this integrated system and process, the equipment set for the VGR system comprises an absorber column 18 with, for example, 5 to 50, or 10 to 30, or 15 to 25 theoretical stages. The optional first silica gel absorbent bed 26 is positioned to receive a process stream comprised of hydrogen and TCS vapor provided by way of conduit 24.1 from the recycle gas compressor 24. The optional silica gel bed 26 will, in this process configuration, reduce boron content in polysilicon by 10% up to 40% compared to standard industry practice. In one embodiment, the present disclosure provides this integrated polysilicon manufacturing plant. Indeed, in various embodiments of the disclosure, any one or more (or indeed all) of these optional reactors/units etc. may be included within the statement of the presently disclosed process and/or system.

FIG. 1B is a schematic block diagram for an optional refrigerated condenser system and/or process that may be present and/or used in combination with the system and process illustrated in FIG. 1A, or indeed with the systems and processes illustrated in any of the Figures provided herein that include exit conduit 18.2 leading from the absorber column 18 and carrying hydrogen and TCS, optionally to the CVD reactor 10. The refrigerated condenser system and/or process shown in FIG. 1B includes a first heat exchanger 30 with exit conduit 30.1 to transfer heat from the gas exiting the absorber column via conduit 18.2 which has optionally traveled through a recycle gas compressor 24 and exit conduit 24.1 as shown in FIG. 1A and optionally through a silica gel bed 26 and exit conduit 26.1 as also shown in FIG. 1A (these options are shown in FIG. 1B as 18.2/24.1/26.1), to a first decanter 32 having an exit conduit 32.1 and an exit conduit 32.2; a second heat exchanger 34 with exit conduits 34.1 and 34.2, where heat exchanger 34 receives gas via conduit 32.1, a second decanter 38, where the second heat exchanger 34 is in fluid communication with a refrigeration unit 36, where refrigerant such as chlorofluorocarbon (e.g., Freon) is transferred from heat exchanger 34 via exit conduit 34.2 to refrigerator 36, and refrigerant is then transferred from refrigerator 36 via exit conduit 36.1 to the second heat exchanger 34. This optional refrigeration process may be used to act upon the hydrogen/TCS recycle stream obtained from the recycle gas compressor 24 which may be, for example, a hydrogen/TCS stream compressor and de-mister. The optional refrigeration process provides a pure hydrogen stream which exits heat exchanger 30 through exit conduit 30.2, where the pure hydrogen stream may optionally be delivered to the reactor 10 (see FIG. 1A), optionally via valve 29 (see FIG. 1A). In addition, the optional refrigerated condenser system and process of FIG. 18 provides a pure or highly enriched TCS stream through either one or both of the first decanter 32 having exit conduit 32.2 and second decanter 38 having exit conduit 38.2, where the contents of exit conduit 32.2 and exit conduit 38.2 may merge at mixer 39 to provide pure or enriched TCS through exit conduit 39.1. An exit conduit 38.1 from second decanter 38 may deliver a hydrogen containing stream to the first heat exchanger 30, as shown in FIG. 1B. In various embodiments of the disclosure, any one or more (or indeed all) of these optional reactors/units etc. may be included within the statement of the present process and/or system.

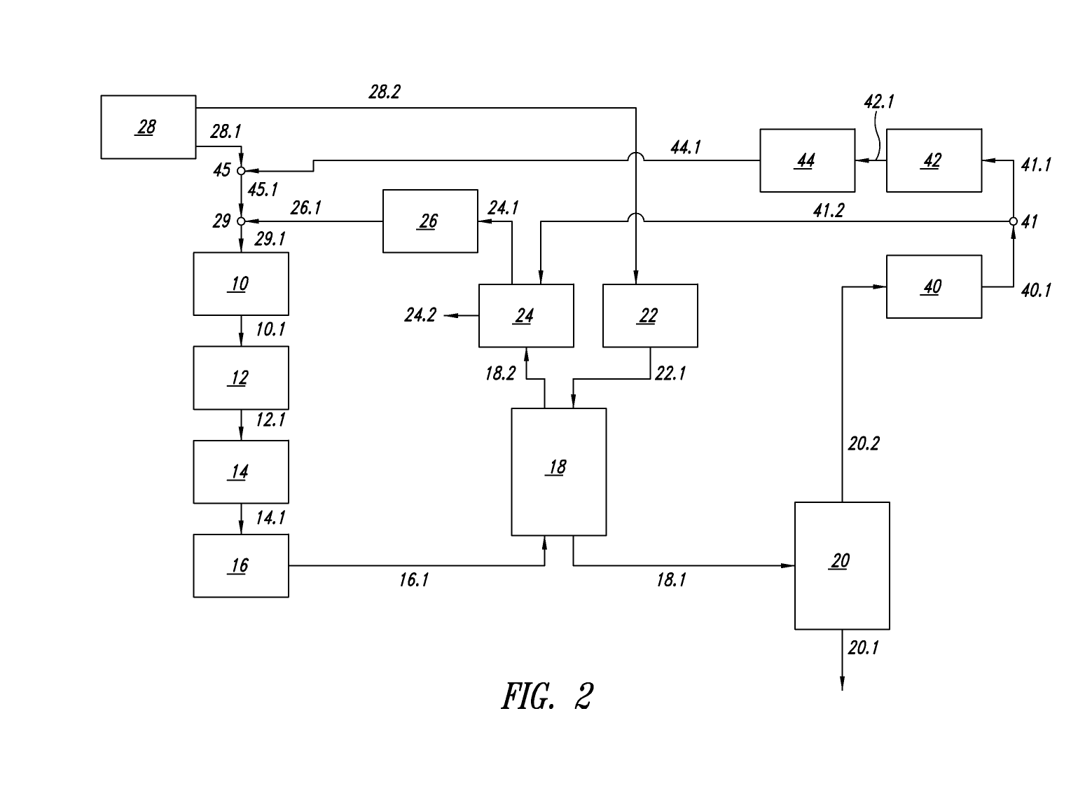

FIG. 2 is a schematic block diagram for another integrated system and/or process for manufacturing polysilicon, which includes or incorporates the VGR system of the present disclosure. As in FIG. 1A, this integrated process includes an optional CVD reactor 10 with exit conduit 10.1, an optional HCl converter reactor 12 with exit conduit 12.1, optional heat recovery equipment 14 with exit conduit 14.1, and an optional vent gas cooling system 16 with exit conduit 16.1. The configuration shown in FIG. 2 provides a VGR system of the present disclosure 18 having exit conduits 18,1 and 18.2. In addition, and as in FIG. 1A, the configuration of FIG. 2 provides an optional recycle gas compressor 24 with exit conduit 24.1 and optional exit conduit 24.2, e.g., a hydrogen/TCS stream compressor and de-mister from which gas may exit by either or both of exit conduit 24.1 or 24.2. Gas exiting optional conduit 24.2 provides a hydrogen bleed going to, for example, an STC hydrochlorination reactor (not shown). Exit conduit 24.1 provides gas delivery to an optional silica gel bed 26 with exit conduit 26.1. The exit conduit 26.1 may lead directly to reactor 10, or it may lead to an optional refrigerated condenser system as shown in FIG. 18, and then optionally to the CVD reactors 10. As mentioned in the discussion of FIG. 1A, optionally the contents of exit conduit 26.1 may be combined with the contents of exit conduit 28.1 at a valve 29 as shown in FIG. 2 to as to provide an exit conduit 29.1 which delivers a combination of hydrogen and TCS to a reactor 10. The configuration of FIG. 2 also provides an optional TCS/STC distillation unit 20 with exit conduits 20.1 and 20.2, for STC/TCS/DCS separation so as to provide STC separated from other components. Exit conduit 20.1 may deliver an STC enriched first fraction to, for example, an STC hydrochlorination reactor (not shown) or an STC converter (not shown). Exit conduit 20.2 may deliver a TCS/DCS enriched second fraction to an optional second silica gel bed 40 with exit conduit 40.1. The exit conduit 40.1 may lead directly to recycle gas compressor 24, or exit conduit 40.1 may lead directly to an optional condenser 42 having exit conduit 42.1 leading to an optional in-process storage tank for TCS/DCS 44 having exit conduit 44.1 which leads to reactor 10, optionally through valve 45 and exit conduit 45.1. Alternatively, and as shown in FIG. 2, the exit conduit 40.1 may pass through a valve 41 which directs or splits the contents within the exit conduit 40.1 into conduits 41.1 and/or 41.2, where conduit 41.1 delivers the contents of the conduit to the compressor 24, and the conduit 41.2 delivers the contents of the conduit to the reactor 10, optionally after passing through the condenser 42 and the tank 44.

The process and/or system illustrated in FIG. 2 also provides an optional in-process TCS tank 22 with exit conduit 22.1 that delivers TCS to the absorber 18, where the tank 22 may receive TCS from a tank 28 via exit conduit 28.2 that delivers TCS from tank 28 to tank 22. The tank 44, if present, has an exit conduit 44.1 that provides TCS and/or DCS to the reactor 10, optionally via valve 45 and exit conduit 45.1. In this case, the equipment used for the VGR system of the present disclosure comprises an absorber column 18 with, for example, 10 to 30 theoretical stages, and an optional TCS/STC distillation unit 20 optionally operating in concert with a second silica gel absorbent bed 40 on a process stream comprised of TCS and DCS vapor. The optional silica gel bed 40 will, in this system and process configuration, remove some or all of the boron species present in the TCS/DCS stream in exit conduit 20.2 that comes from the TCS/STC distillation unit 20. After leaving the silica gel bed 40, the TCS/DCS stream may be directed via exit conduit 40.1 into the recycle gas compressor 24 and/or it may be directed via conduit 40.1 into an optional condenser 42 where it is liquefied and then optionally stored in a TCS/DCS tank 44 from which, optionally, it may be delivered to the CVD reactor 10. In one embodiment, the present disclosure provides this integrated polysilicon manufacturing plant. Indeed, in various embodiments of the disclosure, any one or more (or all) of these optional reactors/units etc. may be included within the statement of the disclosed system and/or process.

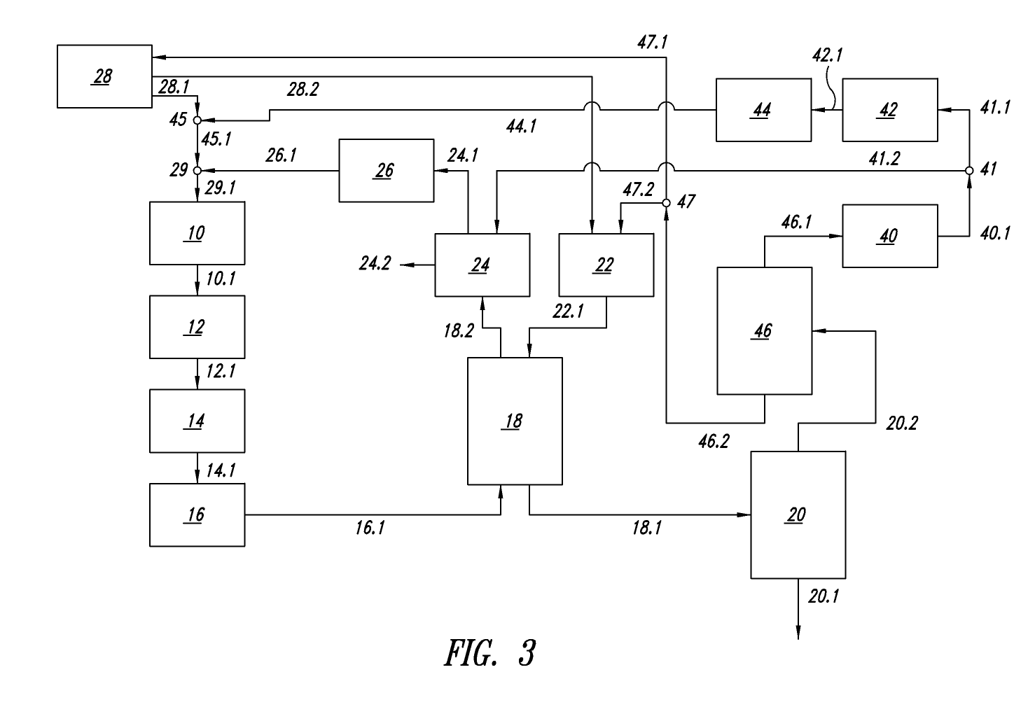

FIG. 3 is a schematic block diagram illustrating another integrated system and/or process that includes the VGR system of the present disclosure. This diagram shows features already described in connection with FIG. 1A, FIG. 1B and FIG. 2. FIG. 3 provides an optional TCS/STC distillation unit 20 with exit conduits 20.1 and 20.2, for STC/TCS/DCS separation so as to provide STC separated from other components as a first fraction and optionally transported by way of exit conduit 20.1 to, for example, an STC hydrochlorination reactor (not shown) or an STC converter (not shown), and/or for TCS/DCS as a second fraction which is delivered by way of exit conduit 20.2 to a DCS/TCS distillation unit 46 whereby a DCS enriched fraction is separated from a TCS enriched fraction. The TCS enriched fraction obtained from DCS/TCS distillation unit 46 may optionally be directed via exit conduit 46.2 to an in-process TCS storage tank 22 from which TCS may be drawn via exit conduit 22.1 and utilized as a reflux component for the STC absorber column 18. Alternatively, the TCS enriched fraction obtained from DCS/TCS distillation unit 46 may optionally be directed via exit conduit 46.2 to a TCS storage tank 28 at the front end of the system/process from which TCS may be drawn and utilized as feedstock for the CVD reactor 10. As shown in FIG. 3, exit conduit 46.2 may alternatively enter valve 47 which may be used to direct the contents of conduit 46.2 to either or both of the tank 28 and tank 22 via conduits 47.1 and 47.2 respectively.

As further shown in FIG. 3, also exiting the DCS/TCS distillation unit 46 is exit conduit 46.1 containing a DCS enriched fraction. Conduit 46.1 may lead to an optional second silica gel bed 40 to remove some, all, or most of the boron species present in the DCS enriched fraction. The resulting boron-free or depleted DCS fraction may be directed via exit conduit 40.1 to the hydrogen stream compressor 24 or into an optional condenser 42 to liquefy the DCS. The liquefied DCS may exit the condenser via exit conduit 42.1 and thereafter be directed to an optional storage tank 44 for DCS storage, which may be used as a source of DCS via exit conduit 44.1, and optionally passing through valve 45 and exit conduit 45.1, for the CVD reactor 10. The optional second silica gel bed 40 on a process stream comprised of DCS vapor may, in this process configuration, reduce boron content in polysilicon by 4× to 10× compared to standard industry practice, or provide for a 75%-90% reduction in boron content in polysilicon.

In FIG. 3, the optional DCS/TCS distillation unit 46 will separate DCS from TCS and may optionally provide for the subsequent sequestration and/or subsequent use as an additive according to a certain, time varying and/or concentration dependent CVD feed gas recipe. The optional first silica gel absorbent bed 26 on a process stream comprised of hydrogen and TCS vapor in the hydrogen gas recycle loop functions as an adjunct to the second silica gel bed 40 on the aforementioned DCS vapor stream, and acts as a back-up boron absorber in case boron breaks through the absorber column 18 and/or the silica gel bed 40 on the DCS vapor stream. In one embodiment, the present process provides this integrated polysilicon manufacturing plant. Indeed, in various embodiments of the disclosure, any one or more (or all) of these optional reactors/units etc. may be included within the statement of the disclosed system and/or process. The process and/or system illustrated in FIG. 3 contains an optional in-process TCS tank 22 with exit conduit 22.1 that delivers TCS to the absorber 18, where the tank 22 may receive TCS from a tank 28 with exit conduit 28.2 that delivers TCS from tank 28 to tank 22. The tank 44, if present, has an exit conduit 44.1 that provides TCS and/or DCS to the reactor 10, optionally via valve 45 and conduit 45.1.

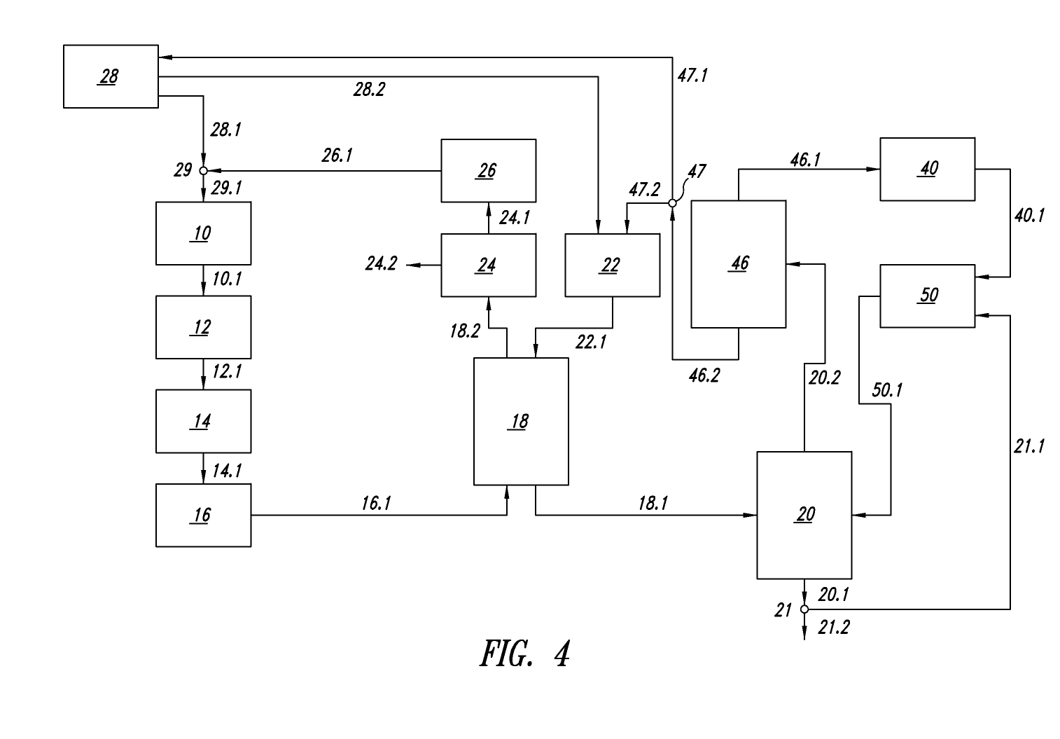

FIG. 4 is a schematic block diagram for an integrated system and/or process of the present disclosure, supplementing the processes illustrated in any one or more of FIGS. 1A, 1B, 2 and 3, and further incorporating a redistribution reactor 50, e.g., an A21 catalyzed redistribution reactor, to which purified DCS and purified STC may be transported and from which a mixture of TCS and STC may be received and then may optionally be transported to the TCS/STC distillation unit 20. FIG. 4 shows an integrated process and/or system that includes a VGR system and process of the present disclosure and further includes an optional TCS/STC distillation unit 20 with exit conduits 20.1 and 20.2, for STC/TCS/DCS separation. STC may be separated from other components to provide a first fraction which is optionally transported by way of exit conduit 20.1 to, for example, an STC hydrochlorination reactor (not shown) or an STC converter (not shown). TCS/DCS may be separated as a second fraction from other components and delivered by way of exit conduit 20.2 to a DCS/TCS distillation unit 46 whereby a DCS enriched fraction is separated from a TCS enriched fraction. The TCS enriched fraction obtained from DCS/TCS distillation unit 46 may optionally be directed via exit conduit 46.2 to an in-process TCS storage tank 22 from which TCS may be drawn via exit conduit 22.1 and utilized as a reflux component for the STC absorber column 18. Alternatively, the TCS enriched fraction obtained from DCS/TCS distillation unit 46 may optionally be directed via exit conduit 46.2 to a TCS storage tank 28 at the front end of the system/process from which TCS may be drawn and utilized as feedstock for the CVD reactor 10. Also exiting the DCS/TCS distillation unit 46 via exit conduit 46.1 is a DCS enriched fraction which may optionally be passed through a second silica gel bed 40 to remove some, all, or most of the boron species present in the DCS enriched fraction, and the resulting boron-free or depleted DCS fraction may be directed via exit conduit 40.1 to a redistribution reactor 50 with an exit conduit 50.1 in fluid communication with the TCS/STC distillation unit 20. The exit conduit 20.1 may also direct the contents thereof, primarily STC, to the redistribution reactor 50. The optional second silica gel bed 40 on a process stream comprised of DCS vapor may, in this process configuration, reduce boron content in polysilicon by 4× to 10× compared to standard industry practice, or provide for a 75%-90% reduction in boron content in polysilicon. The optional DCS/TCS distillation unit 46 will separate DCS from TCS. The optional first silica gel absorbent bed 26 on a process stream comprised of hydrogen and TCS vapor in the hydrogen gas recycle loop functions as an adjunct to the second silica gel bed 40 on the aforementioned DCS vapor stream, and acts as a back-up boron absorber in case boron breaks through the absorber column 18 and/or the silica gel bed 40 on the DCS vapor stream. In one embodiment, the present process provides this integrated polysilicon manufacturing plant. Indeed, in various embodiments of the disclosure, any one or more (or all) of these optional reactors/units etc. may be included within the statement of the disclosed system and/or process. The process and/or system illustrated in FIG. 4 contains an optional in-process TCS tank 22 with exit conduit 22.1 that delivers TCS to the absorber 18, where the tank 22 may receive TCS from a tank 28 with exit conduit 28.2 that delivers TCS from tank 28 to tank 22. In various embodiments of the disclosure, any one or more of these optional reactors/units etc. may be included within the statement of the disclosed system and/or process.

FIG. 5A is a schematic block diagram for an integrated system and/or process that includes the VGR system and process of the present disclosure, having many of the features already described in connection with FIG. 1A, 1B, 2, 3 and 4. In FIG. 5A, unlike FIG. 1A, the absorber column 18 is a TCS absorber column. The optional tank 22 is used for storage of STC rather than, as in FIG. 1A, for storage of TCS. Tank 22 receives STC as a first fraction from the TCS/STC distillation unit 20, via exit conduit 20.1. Optionally, exit conduit 20.1 may connect with valve 21 as shown in FIG. 5A, where conduit 21.1 may leave valve 21 and connect to tank 22, and conduit 21.2 may leave valve 21 and deliver STC to a STC hydrochlorination reactor (not shown) or a STC converter (not shown). In various embodiments of the disclosure, any one or more of these optional reactors/units etc. may be included within the statement of the disclosed system and/or process.

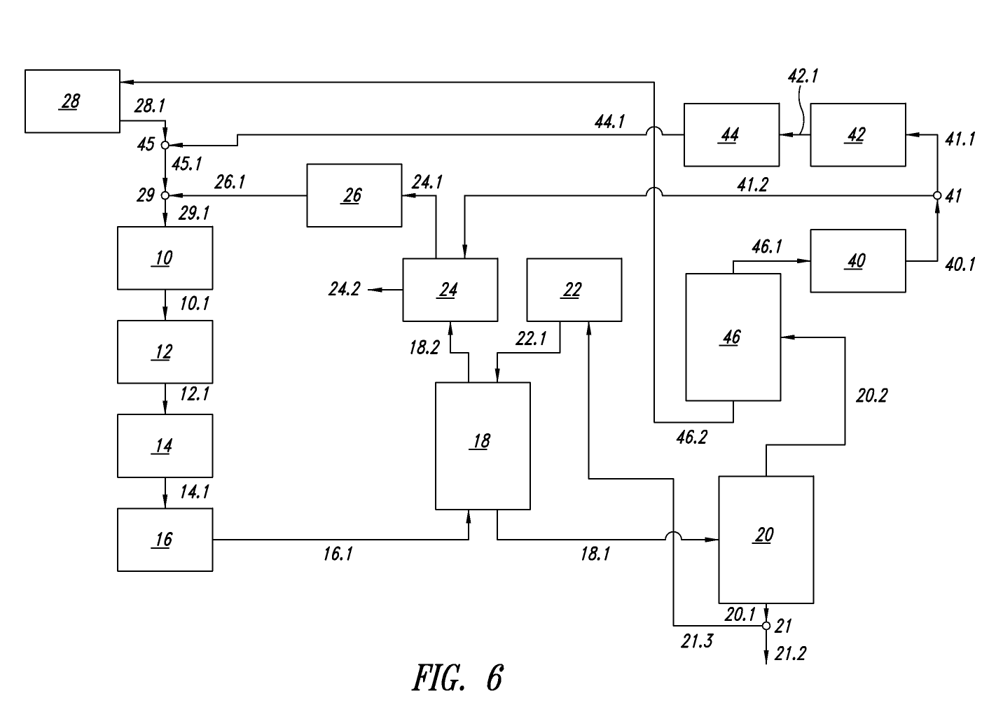

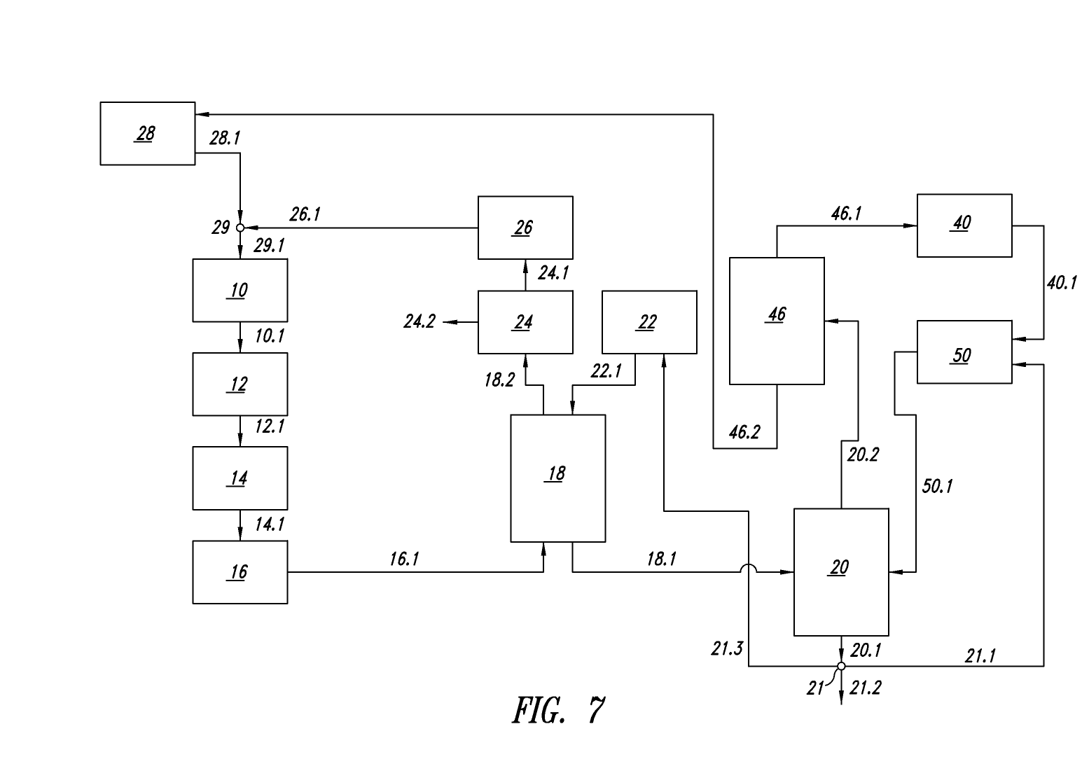

FIG. 5B is a schematic block diagram for an optional refrigerated condenser system and/or process that may be present and/or used in combination with the system and process illustrated in FIG. 5A, and/or FIG. 6 or FIG. 7. The refrigerated condenser system of FIG. 5B is the same as the refrigerated condenser system described in connection with FIG. 18. The refrigerated condenser system and/or process shown in FIG. 5B includes a first heat exchanger 30 with exit conduit 30.1 to transfer heat from the gas exiting the absorber column via conduit 18.2 which has optionally traveled through a recycle gas compressor 24 and exit conduit 24.1 as shown in FIG. 5A and optionally through a silica gel bed 26 and exit conduit 26.1 as also shown in FIG. 5A (these options are shown in FIG. 5B as 18.2/24.1/26.1), to a first decanter 32 having an exit conduit 32.1 and an exit conduit 32.2; a second heat exchanger 34 with exit conduits 34.1 and 34.2, where heat exchanger 34 receives gas via conduit 32.1, a second decanter 38, where the second heat exchanger 34 is in fluid communication with a refrigeration unit 36, where refrigerant (e.g., Freon) is transferred from heat exchanger 34 via exit conduit 34.2 to refrigerator 36, and then refrigerant is transferred from refrigerator 36 via exit conduit 36.1 to the second heat exchanger 34. This optional refrigeration process may be used to act upon the hydrogen/TCS recycle stream obtained from the recycle gas compressor 24 which may be, for example, a hydrogen/TCS stream compressor and de-mister. The optional refrigeration process provides a pure hydrogen stream which exits heat exchanger 30 through exit conduit 30.2, where the pure hydrogen stream may optionally be delivered to the reactor 10 (see FIG. 5A), optionally via valve 29 (see FIG. 5A). In addition, the optional refrigerated condenser system and process of FIG. 5B provides a pure or highly enriched STC stream through either one or both of the first decanter 32 having exit conduit 32.2 and second decanter 38 having exit conduit 38.2, where the contents of exit conduit 32.2 and exit conduit 38.2 may merge at mixer 39 to provide pure or enriched STC through exit conduit 39.1. The pure or enriched STC stream from conduit 39.1 may be recycled to the process, e.g., to the absorber, to an STC converter, or to a hydrochlorination system if present in the plant. An exit conduit 38.1 from second decanter 38 may deliver a hydrogen-containing stream to the first heat exchanger 30, as shown in FIG. 5B. In various embodiments of the disclosure, any one or more (or indeed all) of these optional reactors/units etc. may be included within the statement of the present process and/or system.

FIG. 6 is a schematic block diagram for an integrated system and process including the VGR system and process of the present disclosure, including the system and process illustrated in FIG. 5A and optionally in FIG. 5B, in analogy to FIG. 3. In FIG. 6, the absorber column 18 is a TCS absorber column, and the tank 22 is used to store STC that may optionally be obtained as a first fraction from TCS/STC distillation unit 20 as described in connection with FIG. 5A. The STC in tank 22 may be delivered to the absorber column 18 via exit conduit 22.1. In various embodiments of the disclosure, any one or more of these optional reactors/units etc. may be included within the statement of the disclosed process.

FIG. 7 is a schematic block diagram for an integrated system and process including the VGR system and process of the present disclosure, supplementing the system and processes illustrated in any one or more of FIGS. 5A, 5B and 6, and further incorporating a redistribution reactor 50, e.g., an A21 catalyzed redistribution reactor, to which purified DCS and purified STC may be transported and from which a mixture of TCS and STC may be received and then may optionally be transported to the TCS/STC distillation unit 20. In various embodiments of the disclosure, any one or more of these optional reactors/units etc. may be included within the statement of the disclosed process.

While the purification step is disclosed as an optional embodiment of the process described herein, this purification process has more general applicability. For example, the removal of boron from the hydrogen gas recycle stream and/or from recycle DCS and/or from recycle TCS to the CVD reactor, can be used with standard VGR technology, resulting in substantially reduced boron content in polysilicon product. This may include the use of one, or more than one, silica gel bed.

The systems and processes illustrated in FIGS. 1-7 each include an absorber column; either an STC absorber column as shown in FIGS. 1A-4, or a TCS absorber column as shown in FIGS. 5A-7. However, in other embodiments of the disclosure, an absorber column is not included in the system, and these embodiments are illustrated in FIGS. 8A-11, described as follows.

FIG. 8A is a schematic block diagram for an integrated system and process including a VGR system and process of the present disclosure. The system and process of FIG. 8A provides an optional CVD reactor 10 and exit conduit 10.1 from which polysilicon may be obtained, an HCl converter reactor 12 and exit conduit 12.1, an optional heat recovery unit 14 and exit conduit 14.1, e.g., a steam generator which functions as a heat recovery unit, and an optional vent gas cooling system 16 and exit conduit 16.1, e.g., a cooling water unit which functions as an optional vent gas cooling system. FIG. 8A also shows a recycle gas compressor 24, e.g., a hydrogen/TCS stream compressor and de-mister from which gas may exit by either or both of a hydrogen bleed via exit conduit 24.2 going to, for example, an STC hydrochlorination reactor (not shown), or via exit conduit 24.1 to an optional silica gel bed 26 and then to a refrigerated condenser system as shown in FIG. 8B. FIG. 8A also shows a TCS/STC distillation unit 20 for STC/TCS/DCS separation from which STC may be separated as a first fraction and optionally transported via conduit 20.1, for example, to an STC hydrochlorination reactor (not shown) or STC converter (not shown). Optional exit conduit 20.2 may be used to deliver a TCS/DCS enriched stream as a second fraction to an optional in-process storage tank 44 before delivery to the CVD reactor 10. The mixture of chlorosilanes which enter the TCS/STC distillation unit 20 of FIG. 8A may be produced by the refrigerated condenser system of FIG. 8B, discussed below. In various embodiments of the disclosure, any one or more of these optional reactors units etc. may be included within the statement of the disclosed process.

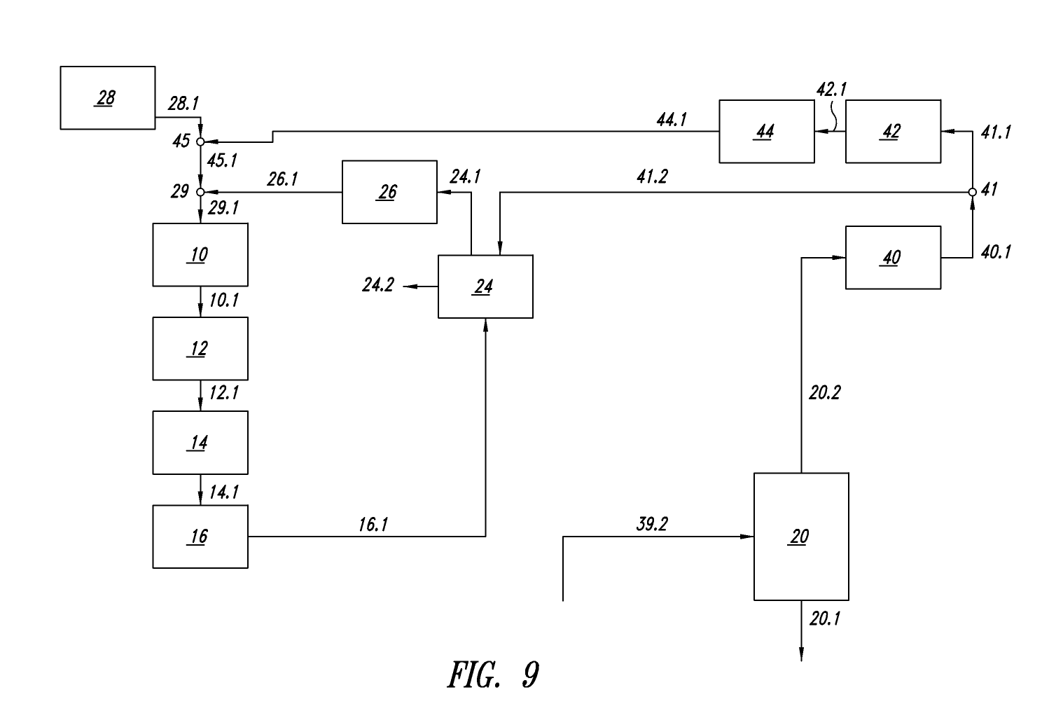

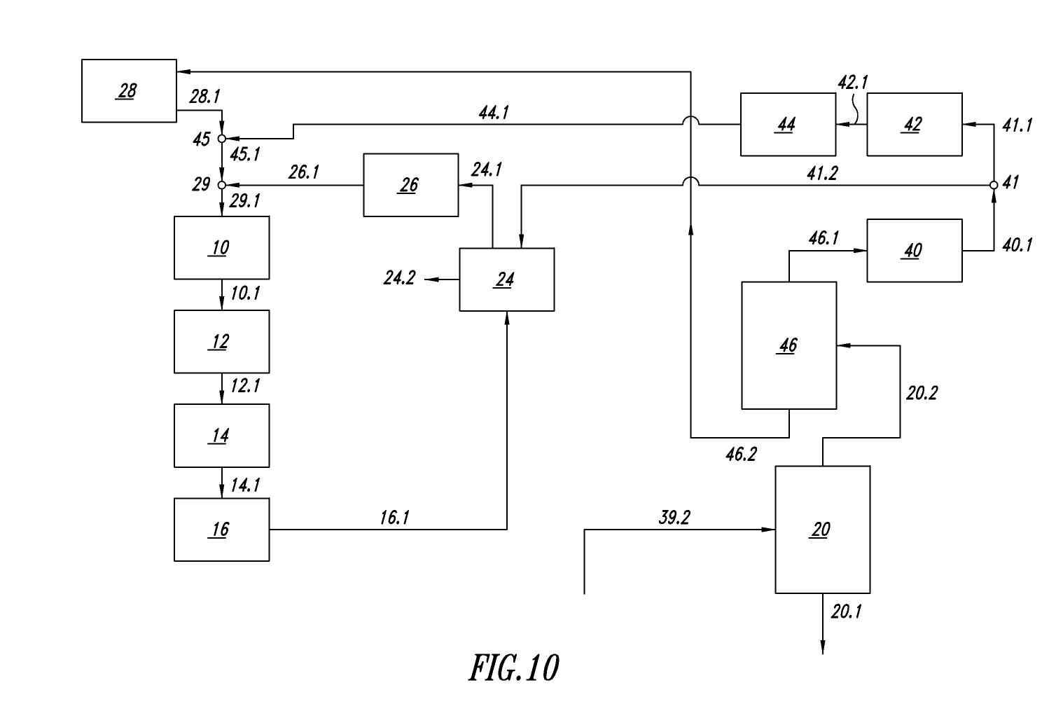

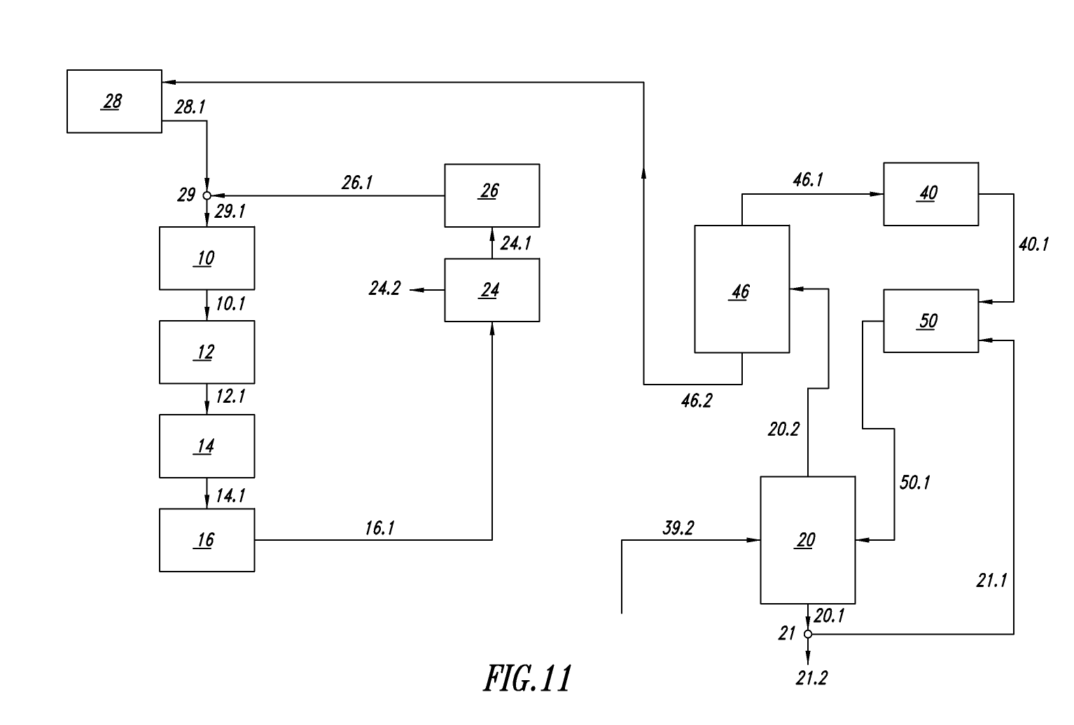

FIG. 8B is a schematic block diagram for a refrigerated condenser system and process in analogy to the refrigerated condenser systems and processes shown in FIG. 1B and FIG. 5B, which is used in conjunction with the system and process illustrated in FIG. 8A, FIG. 9, FIG. 10 and FIG. 11. This refrigerated condenser system and process is used to act upon the hydrogen/mixed chlorosilanes recycle stream obtained from the recycle gas compressor 24 which has not previously gone through an absorber column as shown in FIG. 8A, but which may optionally have travelled through the silica gel bed 26. The refrigerated condenser system and/or process using the refrigerated condenser system shown in FIG. 8B includes a first heat exchanger 30 with exit conduit 30.1 to transfer heat from the gas entering the refrigerated condenser system via conduit 24.1 and optionally 26.1 as shown in FIG. 8A (these options are shown in FIG. 8B as 24.1/26.1), to a first decanter 32 having an exit conduit 32.1 and an exit conduit 32.2; a second heat exchanger 34 with exit conduits 34.1 and 34.2, where heat exchanger 34 receives gas via conduit 32.1, a second decanter 38, where the second heat exchanger 34 is in fluid communication with a refrigeration unit 36, where refrigerant (e.g, Freon) is transferred from heat exchanger 34 via exit conduit 34.2 to refrigerator 36, and refrigerant is transferred from refrigerator 36 via exit conduit 36.1 to the second heat exchanger 34. This refrigerated condenser system and process may be used to act upon the hydrogen/mixed chlorosilane recycle stream obtained from the recycle gas compressor 24, where originally the hydrogen/mixed chlorosilane recycle stream is a vent gas from CVD reactor 10. The refrigerated condenser system and process illustrated in FIG. 8B provides a pure hydrogen stream which exits heat exchanger 30 through exit conduit 30.2, where the pure hydrogen stream may optionally be delivered to the reactor 10. In addition, the refrigerated condenser system and process of FIG. 8B provides a mixed chlorosilanes stream through either one or both of the first decanter 32 having exit conduit 32.2 and second decanter 38 having exit conduit 38.2, where the contents of exit conduit 32.2 and exit conduit 38.2 may merge at mixer 39 to provide mixed chlorosilanes through exit conduit 39.1. These mixed chlorosilanes may be delivered to the TCS/STC distillation unit 20 as shown in FIG. 8A, whereby STC can be separated from TCS and optionally DCS if present. An exit conduit 38.1 from second decanter 38 may deliver a hydrogen-containing stream to the first heat exchanger 30, as shown in FIG. 8B. In various embodiments of the disclosure, any one or more (or indeed all) of these optional reactors/units etc. may be included within the statement of the present process and/or system.

FIG. 9 is a schematic block diagram for an integrated system and process including a VGR system and process of the present disclosure, including the system and processes illustrated in FIG. 8A and in FIG. 8B. FIG. 9 illustrates further including a silica gel bed 40 to treat the TCS/DCS stream, also referred to as the second fraction, exiting the TCS/STC distillation unit 20 via exit conduit 20.2. Silica gel bed 40 includes exit conduit 40.1 for allowing the treated stream to enter the recycle gas compressor, e.g., hydrogen/TCS stream compressor and de-mister, 24, and/or an optional condenser 42 and an optional TCS/DCS tank 44 located between the optional silica gel bed 40 and the entry to the optional CVD reactor 10. In various embodiments of the disclosure, any one or more of these optional reactors/units etc. may be included within the statement of the disclosed process.

FIG. 10 is a schematic block diagram for an integrated system and process including a VGR system and process of the present disclosure, supplementing the processes illustrated in FIG. 9 which incorporates elements as described previously for FIGS. 8A and 8B, and further including a DCS/TCS distillation unit 46 to act on the TCS/DCS stream, also referred to as a second fraction, via conduit 20.2 from the TCS/STC distillation unit 20, including conduit 46.2 from the DCS/TCS distillation unit 46 to transport the separated TCS to the front end TCS tank 28, and including conduit 46.1 from the DCS/TCS distillation unit 46 to transport separated DCS through an optional silica gel bed 40, and then to one or both of the hydrogen/TCS stream compressor and de-mister 24 and/or an optional condenser 42 and optional DCS tank 44 with an optional conduit 44.1 leading to optional valve 45 and exit conduit 45.1 and then to the CVD reactor. In various embodiments of the disclosure, any one or more of these optional reactors/units etc. may be included within the statement of the disclosed process.

FIG. 11 is a schematic block diagram for an integrated system and process including a VGR system and process of the present disclosure, supplementing the systems and processes illustrated in any one or more of FIGS. 8A, 8B, 9 and 10, and further incorporating a redistribution reactor 50, e.g., an A21 catalyzed redistribution reactor, to which purified DCS and purified STC may be transported and from which a mixture of TCS and STC may be received and then may optionally be transported to the TCS/STC unit 20 via conduit 50.1. In various embodiments of the disclosure, any one or more of these optional reactors/units etc. may be included within the statement of the disclosed process.

Accordingly, exemplary process and system embodiments of the present disclosure include the following embodiments which are numbered for convenience:
1. A process comprising:
a. introducing a vent gas comprising hydrogen, hydrochlorosilane and hydrochloric acid to an HCl converter reactor comprising a metal catalyst, and contacting the vent gas with the metal catalyst to provide a product gas comprising less hydrochloric acid than was present in the vent gas, and removing the product gas from the reactor;
b. separating components of the product gas to provide a first fraction enriched in hydrogen and second fraction enriched in chlorosilanes; and
c. introducing the second fraction into a distillation unit, to generate a third fraction enriched in trichlorosilane (TCS) and dichlorosilane (DCS) and a fourth fraction enriched in silicon tetrachloride (STC).
2. The process of embodiment 1 wherein step b) comprises introducing the product gas, optionally all of the product gas, from step a) into an absorber column to provide the first and second fractions.
3. The process of embodiment 2 wherein the product gas from step a) is introduced into the bottom of an absorber column, reflux comprising at least one of TCS and STC is introduced into the top of the absorber column, the second fraction enriched in chlorosilanes is withdrawn as a liquid from the bottom of the absorber column, and the first fraction enriched in hydrogen is withdrawn as a gas from the top of the absorber column.
4. The process of embodiment 3 wherein the reflux comprises TCS and the first fraction comprises hydrogen and TCS.
5. The process of embodiment 3 wherein the reflux comprises STC and the first fraction comprises hydrogen and STC.
6. The process of embodiment 2 wherein the first fraction is introduced into a refrigerated condenser system to separate hydrogen from chlorosilanes.
7. The process of embodiment 1 wherein step b) comprises introducing the product gas, optionally all of the product gas, from step a) into a refrigerated condenser system to provide the first fraction and the second fraction.
8. The process of embodiment 7 wherein the refrigerated condenser system comprises a refrigerator, refrigerant, a heat exchanger and a decantor.
9. The process of embodiment 1 wherein contacting a vent gas comprising hydrochloric acid, silicon tetrachloride, trichlorosilane, and dichlorosilane with a metal catalyst is performed at super-ambient temperature, and the product gas is maintained at super-ambient temperature, optionally entirely in a gas state, between exiting the HCl converter reactor and being separated into first and second fractions.
10. The process of embodiment 2 wherein the product gas is entirely in the gas phase upon being introduced into the absorber column.
11. The process of embodiment 6 wherein the product gas is entirely in the gas phase upon being introduced into the refrigerated condenser system.
12. The process of embodiment 1 wherein the first fraction comprising hydrogen is passed through a silica gel bed wherein boron is removed from the first fraction to provide a boron-depleted first fraction.
13. The process of embodiment 12 wherein the boron-depleted first fraction is passed through a refrigerated condenser system where gas phase chlorosilane is converted to liquid phase chlorosilane, while the hydrogen remains in a gas phase and exits the refrigerated condenser system as a purified H₂ gas stream containing less chlorosilane than does the boron-depleted first fraction.
14. The process of embodiment 13 wherein the purified H₂ gas stream is contacted with a carbon absorbent, and a residual amount of chlorosilane and optionally hydrocarbon in the purified H₂ gas stream is absorbed into the carbon absorbent to provide a highly pure H₂ gas stream containing less chlorosilane than does the purified H₂ gas stream.
15. A system comprising:
a. an HCl converter reactor;
b. an absorber column; and
c. a TCS/STC distillation unit; where the absorber column is in fluid communication with and can receive vent gas exiting the HCl converter reactor, and where the TCS/STC distillation unit is in fluid communication with and can receive a liquid bottoms stream from the absorber column.
16. A system of embodiment 15 comprising:
a. an HCl converter reactor which may i) receive hydrogen, HCl and trichlorosilane, ii) consume HCl, and iii) produce silicon tetrachloride in the presence of a metal catalyst; an absorber column which may i) receive hydrogen, trichlorosilane and silicon tetrachloride and ii) generate a first fraction comprising hydrogen and a second fraction comprising a mixture of trichlorosilane and the silicon tetrachloride;
c. a TCS/STC distillation unit which may i) receive a mixture of trichlorosilane and silicon tetrachloride and ii) separate the trichlorosilane from the silicon tetrachloride; and
d. a silica gel bed which may i) receive a composition comprising at least one of DCS and TCS and ii) absorb boron and/or phosphorus impurities from the composition.
17. A system comprising:
a. an HCl converter reactor;
b. a refrigerated condenser system; and
c. a TCS/STC distillation unit; where the refrigerated condenser system is in fluid communication with and can receive vent gas exiting the HCl converter reactor, and where the TCS/STC distillation unit is in fluid communication with and can receive an effluent stream from the refrigerated condenser system.
18. A system of embodiment 17 comprising:
a. an HCl converter reactor which may i) receive hydrogen, HCl and trichlorosilane, ii) consume HCl, and iii) produce silicon tetrachloride in the presence of a metal catalyst;
b. a refrigerated condenser system which may i) receive hydrogen, trichlorosilane and silicon tetrachloride and ii) generate a first fraction comprising hydrogen and a second fraction comprising a mixture of trichlorosilane and the silicon tetrachloride;
c. a TCS/STC distillation unit which may i) receive a mixture of trichlorosilane and silicon tetrachloride and ii) separate the trichlorosilane from the silicon tetrachloride; and
d. a silica gel bed which may i) receive a composition comprising at least one of DCS and TCS and ii) absorb boron and/or phosphorus impurities from the composition.
19. A vent gas recovery system that comprises a silica gel bed.
20. The vent gas recovery system of embodiment 19 further comprising an HCl converter reactor and a TCS/STC distillation unit.

In regard to any of the foregoing embodiments numbered 1-20 or other embodiments disclosed herein, the process and/or system of the present disclosure may be further described by providing details concerning the third and fourth fractions. For example, after formation of the third and fourth fractions in a distillation unit, which may be referred to herein for clarity as the TCS/STC distillation unit in order to distinguish this unit from an optional TCS/DCS distillation unit identified below, the third and fourth fractions may be subjected to any one or more of the following, where each of the following provides an embodiment of the present disclosure in combination with any of the process embodiments 1-14 or system embodiments 15-20:
a. the third fraction comprising TCS/DCS, optionally after being stored in a tank, e.g., tank (28) or tank (44), is combined with hydrogen to provide a feedstock for a CVD reactor wherein polysilicon is produced;
b. the third fraction comprising TCS/DCS may be stored until it is needed in the plant, e.g., it may be stored in a tank (22) until it is used as reflux in an absorber column (18);
c. the third fraction comprising TCS/DCS is contacted with a silica gel bed, e.g., (40), where the silica gel absorbs boron from the third fraction and a boron-depleted fifth fraction comprising TCS/DCS is produced;
d. the fifth fraction comprising TCS/DCS is directed to a gas compressor (24) and may ultimately utilized as feedstock in a CVD reactor;
e. the fifth fraction comprising TCS/DCS is combined with hydrogen to provide a feedstock to a CVD reactor, optionally after passing through a condenser (42) and/or a storage tank (44);
f. the third fraction comprising TCS/DCS is separated in a distillation unit into a sixth fraction enriched in TCS and a seventh fraction enriched in DCS;
g. the sixth fraction comprising TCS may be directed to a storage tank (22) to be used as reflux for an absorber (18) or for any other purpose for which TCS may be needed in the plant;
h. the sixth fraction comprising TCS, optionally after being stored in a tank, e.g., tank (28), is combined with hydrogen to provide a feedstock for a CVD reactor wherein polysilicon is produced;
i. The seventh fraction comprising DCS, which may also contain boron and/or phosphorus, is sent to a waste treatment facility;
j. the seventh fraction comprising DCS is contacted with silica gel, and boron is absorbed from the seventh fraction into the silica gel to provide an eighth fraction comprising DCS and little or no boron;
k. the eighth fraction comprising DCS is directed to a gas compressor (24) and may ultimately utilized as feedstock in a CVD reactor;
l. the eighth fraction comprising DCS is combined with hydrogen to provide a feedstock to a CVD reactor, optionally after passing through a condenser (42) and/or a storage tank;
m. the eighth fraction comprising DCS, along with STC which may be provided, for example, by the fourth fraction, are directed to a redistribution reactor (50) to provide a ninth fraction comprising TCS and optionally minor amounts of DCS and/or STC;
n. the fourth fraction comprising STC is directed to an STC converter;
o. the fourth fraction comprising STC is directed to an SIC hydrochlorinator;
p. the fourth fraction comprising STC, along with DCS which may be provided, for example, by the 8^{th} fraction, is directed to a redistribution reactor (50), to provide a ninth fraction comprising TCS and optionally minor amounts of DCS and/or STC; and
q. the fourth fraction comprising STC may be directed to a storage tank, e.g., tank (22), for storage until it is needed in the plant, for example, it may be needed as reflux for absorber (18).

As mentioned previously, the system and process described herein, including the many embodiments thereof, provide advantages compared to prior art systems and processes. The following example exemplifies some of the aforementioned differences, and highlights the improvements made possible by the present disclosure. By intentionally controlling the temperature of the vent gas fed to the absorber at, e.g., 50° C. as shown in the example, the need for multiple hydrogen gas coolers and multiple decanters can be avoided. Further, the hydrogen recycle gas stream which exits the absorber can be pre-loaded with 85% of the TCS vapor required by the CVD reactor. Pre-loading the hydrogen recycle gas stream thus greatly reduces the thermal energy load on the CVD reactor system, by using thermal energy in the vent gas stream. Advantageously, this thermal energy is not wasted by contacting it with, e.g., cooling water. The use of cooling water is high energy intensive, in terms of moving water, and also leads to significant evaporation of water. Finally, running the vent gas temperature at, e.g., 50° C. as shown in the example, reduces the load on the TCS/STC distillation unit by ⅓rd compared to cooling the vent gas stream to, for example, 35° C. In addition, the present disclosure may be operated so as to provide two additional major benefits: (1) in one embodiment, the process described herein removes boron (BCl₃), as present in CVD vent gas, from the hydrogen gas recycle stream to the CVD reactor, thereby reducing boron content in polysilicon product by 4× to 10×; (2) in another embodiment, the process described herein isolates DCS for conversion to TCS, for recycle to the CVD reactor, or for use in custom CVD reactor recipes calling for time controlled addition of supplemental DCS, to optimize CVD reactor growth curves.

### EXAMPLE

The process and optional embodiments described herein may achieve one or more of a multiplicity of desirable results, including, but not limited to: the reduction of one or more of boron, phosphorous and carbon content in polysilicon, the separation of DCS from recycle TCS recovered in the VGR system, pre-vaporization of TCS for feed into a CVD reactor for the Siemens' process, and the preparation of high purity, low chlorosilane content, hydrogen gas from CVD off-gas for recycle to the CVD reactor. These results are conveniently achieved by making various adjustments to the operating parameters of the process, where the adjustments may be made one at a time, or in a coordinated manner, several optionally being achieved at once. These operating parameters include: the temperature of the vent gas fed to the absorber (variable “A”), the temperature of the reflux to the absorber (variable “B”), the reflux rate to the absorber (variable “C”), and the pressure at which the absorber is operated (variable “D”), which are illustrated in the present example.

As may be seen by reference to the following Table, certain operating parameters may be used to control, e.g., increase, boron removal, measured as the efficiency with which boron as species comprising BCl₃ is removed from the vent gas fed to the absorber:
Controlling, e.g., decreasing, the temperature of the vent gas fed to the absorber case 4 compared to case 1).
Controlling, e.g., decreasing, the temperature of the reflux fed to the absorber (case 4 compared to case 2).
Controlling, e.g., increasing, the reflux rate (case 3 compared to case 1).
Controlling, e.g., increasing, the absorber operating pressure (case 4 compared to case 7).
   The same functionalities increase DCS removal from the vent gas fed to the absorber. The Table shows that efficient boron and DCS removal can be achieved at super ambient feed temperature and super ambient refluxing temperature.

As seen by Table 1, the following functionalities increase TCS pre-vaporization:
Increasing the temperature of the vent gas fed to the absorber (case 1 vs. case 5).
Increasing the temperature of the reflux fed to the absorber (case2 vs. case 6).
Increasing the reflux rate (case 3 vs. case 4).
Decreasing the absorber operating pressure (case 7 vs. case 4).

TABLE 1

| | A | B | C | D | % BCI3 | % DCS | % TCS |
|---|---|---|---|---|---|---|---|
| Case | ′C | ′C | kg/hr | PSIG | Removal | Removal | Vaporization |
| 1 | 25 | 35 | 30,000 | 90 | 100.0% | 99.8% | 44% |
| 2 | 35 | 25 | 30,000 | 90 | 96.6% | 91.7% | 53% |
| 3 | 35 | 35 | 15,000 | 90 | 58.0% | 54.0% | 53% |
| 4 | 35 | 35 | 30,000 | 90 | 94.8% | 89.4% | 56% |
| 5 | 50 | 35 | 30,000 | 90 | 62.6% | 56.7% | 83% |
| 6 | 35 | 50 | 30,000 | 90 | 91.4% | 85.6% | 61% |
| 7 | 35 | 35 | 30,000 | 120 | 99.4% | 97.1% | 50% |
| 8 | 35 | 35 | 15,000 | 120 | 66.1% | 61.8% | 47% |
| 9 | 35 | 35 | 10,000 | 120 | 52.5% | 49.0% | 46% |
| 10 | 35 | 35 | 22,000 | 120 | 85.1% | 79.7% | 48% |
| 11 | 35 | 25 | 30,000 | 120 | 99.7% | 98.2% | 46% |

Legend:
A = CVD Vent Gas Temperature
B = Absorber Reflux Temperature
C = Absorber Reflux Rate
D = Absorber Pressure
Note 1:
STC removal from hydrogen recycle stream is >99% in each case shown.
Note 2:
CVD vent gas feed rate used in Table 1 is 1,700 kg/hr hydrogen, 30 kg/hr BCI3, and approximately 30,000 kg/hr chlorosilanes comprising DCS, TCS, and STC, containing predominantly TCS and STC, in a 1.5:1 TCS:STC weight ratio. However, these values are for illustrative purposes, and similar concentration profiles or flow rates may also be used.
Note 3:
% TCS Vaporization refers to pre-vaporization.
Note 4:
TCS used as the reflux.

Compared to current industrial practice, the new system envisaged by the present disclosure features: (1) enhanced energy recovery, (2) zero or minimal refrigeration, (3) 80%-90% reduction in electrical consumption, (4) 80%-90% reduction in capital cost compared to current VGR systems, and (5) as much as 4× to 10× reduction in boron content in polysilicon product.

Within embodiments of the present process, the following advantages may be realized by using STC as a reflux component of the reflux delivered in the absorption step compared to using TCS as a reflux component, as described below in reference to Table 2:
In the case where the hydrogen off-gas is sent to a refrigerated condenser system, to condense out most chlorosilane, the residual level of chlorosilane, after refrigeration, is lower when STC is used as reflux. For example, if the hydrogen off-gas is cooled to minus 50° C. (compare cases 1 and 2 in Table 2), the mole fraction chlorosilane in hydrogen is only ¼^{th} as much as when TCS is used as a reflux component of the reflux. If the hydrogen is cooled to minus 70° C. (compare cases 3 and 4 in Table 2), the mole fraction of residual chlorosilane is also ¼^{th} as much as when TCS is used as a reflux component of the reflux. Lower residual chlorosilane makes possible lower capital expenses and lower operating costs for downstream processing steps as is explained elsewhere herein.
In the case where the hydrogen off-gas is sent to a refrigerated condenser system, to condense out most chlorosilane, refrigeration to minus 30° C. gives the same low level of residual chlorosilane when STC is used as a reflux component of the reflux as when the hydrogen stream is refrigerated to minus 50° C. but TCS is used as a reflux component of the reflux (compare Case 2 and Case 5 in Table 2). This is advantageous because it is significantly less costly to refrigerate a hydrogen stream to minus 30° C. than it is to refrigerate it to minus 50° C., due to lower refrigeration load and simpler, required refrigeration equipment.
For a given refrigeration temperature (e.g., minus 50° C.), when the hydrogen recycle stream is polished (purified) in a carbon bed before recycling it to the CVD reactor, the size of the carbon bed need only be roughly ¼^{th} as large when STC is used as a reflux component of the reflux for equivalent operation of the carbon bed, due to lower bed loading (compare Case 1 and Case 2 of Table 2). Conversely, if the same size bed is used regardless of whether STC or TCS is used as a reflux component of the reflux in the absorber step, the bed will last 4 times longer when STC is used as a reflux component, again due to lower bed loading.
Due to the low level of residual chlorosilane in hydrogen recycle obtainable when STC is used as a reflux component of the reflux (e.g., Case 1 and Case 3), the carbon beds can be eliminated from the process, and the hydrogen can be sent directly from the refrigerated condenser system to the CVD reactor. The amount of residual STC in the recycle hydrogen, in the case where the hydrogen stream is refrigerated to minus 50° C., will be less than 10% of the STC present in the off-gas from the CVD reactor, even less than 5%, and even an amount equal to 1%.
In the present process, when STC is a reflux component of the reflux delivered to the absorber, less energy is required to perform the subsequent TCS/STC distillation step, where TCS is separated overhead, as a gas from the TCS/STC distillation unit, from STC, which leaves as a liquid stream from the bottom of the TCS/STC distillation unit. Because STC, refluxed to the absorber as a liquid, is removed from the absorber as a liquid bottoms stream and is removed in the subsequent TCS/STC distillation step, where it is separated from TCS as a liquid bottoms stream, the energy required to operate the TCS/STC distillation step is greatly reduced—compared to the case where TCS is used as a reflux component of the reflux.
In the case where the hydrogen off-gas is sent to a refrigerated condenser system, to condense out most chlorosilane, the residual level of chlorosilane, after refrigeration, is lower when STC is used as a reflux component of the reflux than when mixed chlorosilane is used as a reflux component. For example, if the hydrogen off-gas is cooled to minus 50° C. (compare Case 1 and Case 6 in the Table), the mole fraction chlorosilane in hydrogen is only ¼^{th} as much when STC is used as a reflux component of the reflux. If the hydrogen is cooled to minus 70° C. (compare Case 3 and 7), the mole fraction residual chlorosilane is also ¼^{th} as much when STC is used as a reflux component of the reflux. Cases 1 and 3, compared to Cases 6 and 7, show that the use of STC as a reflux component of the reflux, according to an option of the present process, is superior to the use of mixed chlorosilanes when the hydrogen recycle stream is to be refrigerated. Lower residual chlorosilane makes possible lower capital expenses for a plant, and lower operating costs for downstream processing steps as is explained elsewhere herein.

TABLE 2

| Case | Temp. | Reflux | | | |
|---|---|---|---|---|---|
| No. | (° C.) | Comp. | *STC in H₂ | *TCS in H₂ | **Mixed in H₂ |
| 1 | −50 | STC | 8.1 × 10⁻⁴ | ***N.A. | N.A. |
| 2 | −50 | TCS | N.A. | 29.7 × 10⁻⁴ | N.A. |
| 3 | −70 | STC | 1.49 × 10⁻⁴ | N.A. | N.A. |
| 4 | −70 | TCS | N.A. | 6.5 × 10⁻⁴ | N.A. |
| 5 | −30 | STC | 32.1 × 10⁻⁴ | N.A. | N.A. |
| 6 | −50 | **Mixed | N.A. | N.A. | 26.4 × 10⁻⁴ |
| 7 | −70 | **Mixed | N.A. | N.A. | 5.9 × 10⁻⁴ |

*Shown as mole fraction STC or TCS in the refrigerated hydrogen gas.
**Mixed chlorosilanes used as reflux comprising mainly TCS and STC in a 1.5:1 TCS:STC weight ratio with a minor amount of DCS.
***N.A. means not applicable.

Having previously described the disclosed invention, in the following there are provided particular embodiments, where these embodiments are exemplary and not the exclusive embodiments of the disclosed process, and where any of the various mentioned embodiments may be combined with other embodiments identified herein. In one embodiment, a process is provided whereby the boron content in polysilicon, the DCS content in hydrogen gas recycle to a Siemens type CVD reactor, and the TCS pre-vaporization are controlled by adjusting (either one at a time or, in a coordinated manner, several of the parameters may be adjusted at once) parameters comprising the temperature of the vent gas fed to the absorber, the temperature of the reflux to the absorber, the reflux rate to the absorber, and the pressure at which the absorber is operated. In another embodiment, a process is provided for reducing boron content in polysilicon that is formed in a Siemens type CVD reactor, where the process includes absorbing boron, present in the CVD off-gas and/or in the hydrogen gas recycle to the CVD reactor, as species comprising BCl₃, into one or more silica gel beds.

Each of the afore-stated embodiments may be further characterized by one or more of the following statements:
boron, as present in the CVD off-gas as a species comprising BCl₃, is first absorbed into chlorosilane reflux in an absorber column;
lighter boiling compounds comprising DCS and BCl₃ are separated from heavier boiling compounds comprising TCS and STC which are present in the absorber column liquid bottoms stream, where optionally the DCS and BCl₃ so separated are fed as a vapor stream to a silica gel bed, and where the BCl₃ in the feed to the silica gel bed is substantially absorbed into the silica gel bed, thereby substantially removing it from the DCS vapor, such that in various embodiments greater than 50% of the BCl₃ in the feed to the silica gel bed is removed from the DCS vapor stream exiting the silica gel bed or greater than 70% of the BCl₃ in the feed to the silica gel bed is removed from the DCS vapor stream exiting the silica gel bed or greater than 90% of the BCl₃ in the feed to the silica gel bed is removed from the DCS vapor stream exiting the silica gel bed or greater than 95% of the BCl₃ in the feed to the silica gel bed is removed from the DCS vapor stream exiting the silica gel bed; or
lighter boiling compounds comprising DCS and TCS are separated from heavier boiling compounds comprising STC present in the absorber column liquid bottoms stream and optionally the DCS and TCS so separated are fed as a vapor stream to a silica gel bed, and where optionally the BCl₃ in the feed to the silica gel bed is substantially absorbed into the silica gel bed, thereby substantially removing it from the DCS and TCS vapor, where in various embodiments greater than 50% of the BCl₃ in the feed to the silica gel bed is removed from the DCS and TCS vapor stream exiting the silica gel bed or greater than 70% of the BCl₃ in the feed to the silica gel bed is removed from the DCS and TCS vapor stream exiting the silica gel bed or greater than 90% of the BCl₃ in the feed to the silica gel bed is removed from the DCS and TCS vapor stream exiting the silica gel bed or greater than 95% of the BCl₃ in the feed to the silica gel bed is removed from the DCS and TCS vapor stream exiting the silica gel bed; or
lighter boiling compounds comprising DCS and BCl₃ are separated from heavier boiling compounds comprising TCS and STC present in a VGR system process stream, and optionally where the DCS and BCl₃ so separated are fed as a vapor stream to a silica gel bed, and where the BCl₃ in the feed to the silica gel bed is substantially absorbed into the silica gel bed, thereby substantially removing it from the DCS vapor exiting the bed;
hydrogen gas recycle to the Siemens type CVD reactor is fed as a vapor to a silica gel bed, and where the BCl₃ in the feed to the silica gel bed is substantially absorbed into the silica gel bed, thereby removing it from the hydrogen gas recycle stream; where in optional embodiments greater than 10% of the BCl₃ in the feed to the silica gel bed is removed from the hydrogen gas recycle stream exiting the silica gel bed, or greater than 20% of the BCl₃ in the feed to the silica gel bed is removed from the hydrogen gas recycle stream exiting the silica gel bed, or greater than 30% of the BCl₃ in the feed to the silica gel bed is removed from the hydrogen gas recycle stream exiting the silica gel bed, or greater than 40% of the BCl₃ in the feed to the silica gel bed is removed from the hydrogen gas recycle stream exiting the silica gel bed;
hydrogen gas, exiting the CVD off-gas absorber column, comprising recycle to the CVD reactor, is fed as a vapor to a silica gel bed, and where some or all of the BCl₃ in the feed to said silica gel bed is absorbed into the silica gel bed, thereby removing some or all of the BCl₃ from said hydrogen gas recycle stream, where in one embodiment between 10 and 40% of the BCl₃ is removed by absorption into the silica gel bed;
hydrogen gas, exiting the CVD off-gas absorber column, comprising recycle to the CVD reactor, is fed as a vapor to a first silica gel bed, and where the BCl₃ in the feed to said silica gel bed is substantially absorbed into the silica gel bed, thereby substantially removing it from said hydrogen gas recycle stream, and where the DCS and BCl₃ in the absorber column bottoms stream are separated and are fed as a vapor stream to a second silica gel bed, and where the BCl₃ in the feed to said silica gel bed is substantially absorbed into said silica gel bed, thereby substantially removing it from the DCS vapor;
the chlorosilane reflux comprises TCS as a reflux component, and in fact the reflux is substantially comprised of TCS; where in various embodiments the TCS concentration in the reflux is greater than 80 wt % TCS, or where the TCS concentration in the reflux is greater than 90 wt % TCS, or where the TCS concentration in the reflux is greater than 95 wt % TCS, or where the TCS concentration in the reflux is greater than 99 wt % TCS;
the chlorosilane reflux comprises STC as a reflux component, and in fact the reflux is substantially comprised of STC; where in various embodiments the STC concentration in the reflux is greater than 80 wt % STC, or where the STC concentration in the reflux is greater than 90 wt % STC, or where the STC concentration in the reflux is greater than 95 wt % STC, or where the STC concentration in the reflux is greater than 99 wt % STC;
one or more variables including the temperature of the CVD off-gas fed to the absorber column, the temperature of reflux to the absorber column, the reflux rate to the absorber column—for a selected off-gas rate, and the absorber operating pressure are controlled individually, or in concert, to absorb boron as species comprising BCl₃ from the CVD off-gas fed to the absorber;
one or more variables including the temperature of the CVD off-gas fed to the absorber column, the temperature of reflux to the absorber column, the reflux rate to the absorber column—for a selected off-gas rate, and the absorber operating pressure (the “independent variables”) are controlled individually, or in concert, to absorb boron as species comprising BCl₃ from the CVD off-gas fed to the absorber in a manner designed to optimize a certain variable (the “dependent” variable), comprising cost of operation to achieve a certain reduction of boron content in polysilicon formed in a Siemens type CVD reactor; where the dependent variable being optimized is calculated using analogue or digital means, and where the digital means may comprise a computer program, such as a process simulation program, linked to the independent variables, and where the optimization may be performed at a certain point in time for later use in polysilicon plant control, or may be linked in real time for on-line plant process control, where the dependent variable may be optimized using a technique known in the industry as multi-variable optimization, where the temperature of the CVD off-gas fed to the absorber column is controlled between −20° C. and +100° C. or where the temperature of the CVD off-gas fed to the absorber column is controlled between +10° C. and +70° C. or where the temperature of the CVD off-gas fed to the absorber column is controlled between +25° C. and +50° C., and where the temperature of the CVD off-gas fed to the absorber column is controlled at 35° C., where the temperature of the reflux to the absorber column is controlled between −20° C. and 470° C. or where the temperature of the reflux to the absorber column is controlled between +10° C. and +50° C. or where the temperature of the reflux to the absorber column is controlled at 35° C.; where the weight ratio of the reflux to the absorber to the vent gas feed rate to the absorber is controlled between 0.2:1 to 2:1 or the weight ratio of the reflux to the absorber to the vent gas feed rate to the absorber is controlled between 0.4:1 to 1.75:1 or the weight ratio of the reflux to the absorber to the vent gas feed rate to the absorber is controlled between 0.5:1 to 1.25:1 or the weight ratio of the reflux to the absorber to the vent gas feed rate to the absorber is controlled at 1:1. where the operating pressure of the absorber is controlled between 30 psig and 200 psig or the operating pressure of the absorber is controlled between 50 psig and 150 psig or the operating pressure of the absorber is controlled between 80 psig and 130 psig or the operating pressure of the absorber is controlled at 120 psig.

In another embodiment, there is provided a process for reducing DCS content in hydrogen gas recycle to a Siemens type CVD reactor including first absorbing DCS, in the reactor vent gas exiting a Siemens type CVD reactor, into a chlorosilane reflux stream passing down an absorber column where the chlorosilane reflux is substantially comprised of TCS. In various optional embodiments:
the TCS concentration in the reflux is greater than 80 wt % TCS or the TCS concentration in the reflux is greater than 90 wt % TCS or the TCS concentration in the reflux is greater than 95 wt % TCS or the TCS concentration in the reflux is greater than 99 wt % TCS;
one or more variables selected from the temperature of the CVD off-gas fed to the absorber column, the temperature of reflux to the absorber column, the reflux rate to the absorber column—for a selected off-gas rate, and the absorber operating pressure are controlled individually, or in concert, to achieve absorption of DCS from the CVD off-gas fed to the absorber
lighter boiling compounds comprising DCS are separated from heavier boiling compounds comprising TCS and STC present in the absorber column liquid bottoms stream, and where the DCS so separated may be substantially converted to TCS by reaction with STC in a redistribution reactor or where the DCS so separated may be stored for later use as supplemental feed to the CVD reactor, and where the product of the redistribution reactor may be separated by distillation into product streams comprising a stream containing substantially TCS for feed to the CVD reactor and where in optional embodiments the TCS stream so separated contains greater than 50 wt % TCS or the TCS stream so separated contains greater than 70 wt % TCS or the TCS stream so separated contains greater than 90 wt % TCS or the TCS stream so separated contains greater than 95 wt % TCS;
variables selected from the temperature of the CVD off-gas fed to the absorber column, the temperature of reflux to the absorber column, the reflux rate to the absorber column—for a selected off-gas rate, and the absorber operating pressure (the “independent variables”) are controlled individually, or in concert, to achieve absorption of DCS from the CVD off-gas fed to the absorber in a manner designed to optimize a certain variable (the “dependent” variable), such as the cost of operation to achieve a certain reduction of DCS content in hydrogen gas recycle to a Siemens type CVD reactor, where the dependent variable being optimized is calculated using analogue or digital means, and where the digital means may comprise a computer program, such as a process simulation program, linked to the independent variables, and where the optimization may be performed at a certain point in time for later use in polysilicon plant control, or may be linked in real time for on-line plant process control, where the dependent variable may be optimized using a technique known in the industry as multi-variable optimization;
the temperature of the CVD off-gas fed to the absorber column is controlled between −20° C. and +100° C. or the temperature of the CVD off-gas fed to the absorber column is controlled between +10° C. and +70° C. or the temperature of the CVD off-gas fed to the absorber column is controlled between +25° C. and +50° C. or the temperature of the CVD off-gas fed to the absorber column is controlled at +35° C.;
the temperature of reflux to the absorber column is controlled between −20° C. and +70° C. or the temperature of the CVD off-gas fed to the absorber column is controlled between +10° C. and +50° C. or the temperature of the CVD off-gas fed to the absorber column is controlled at 35° C.;
the weight ratio of the reflux to the absorber to the vent gas feed rate to the absorber is controlled between 0.2:1 to 2:1 or the weight ratio of the reflux to the absorber to the vent gas feed rate to the absorber is controlled between 0.4:1 to 1.75:1 or the weight ratio of the reflux to the absorber to the vent gas feed rate to the absorber is controlled between 0.5:1 to 1.25:1 or the weight ratio of the reflux to the absorber to the vent gas feed rate to the absorber is controlled at 1:1;
the operating pressure of the absorber is controlled between 30 psig and 200 psig or the operating pressure of the absorber is controlled between 50 psig and 150 psig or the operating pressure of the absorber is controlled between 80 psig and 130 psig or the operating pressure of the absorber is controlled at 120 psig.

In yet another embodiment there is provided a process whereby TCS pre-vaporization is controlled by adjusting, either one at a time or in a coordinated manner several at once, one or more independent variables selected from the temperature of the CVD reactor vent gas stream fed to an absorber, the temperature of the reflux to the absorber, the reflux rate to the absorber, and the pressure at which the absorber is operated, where the reflux stream passing down the absorber column is substantially comprised of TCS. In various additional optional embodiments:
the TCS concentration in gas stream going into the absorber is greater than 40 wt % TCS or the TCS concentration in the reflux is greater than 90 wt % TCS or where the TCS concentration in the reflux is greater than 95 wt % TCS or the TCS concentration in the reflux is greater than 99 wt % TCS;
the variables selected from the temperature of the CVD off-gas fed to the absorber column, the temperature of reflux to the absorber column, the reflux rate to the absorber column—for a specified off-gas rate, and the absorber operating pressure (the “independent variables”) are controlled individually, or in concert, to optimize a certain variable (the “dependent” variable), comprising cost of operation to achieve a desired level of TCS pre-vaporization; optionally the value of the dependent variable being optimized is calculated using analogue or digital means, and where the digital means may comprise a computer program, such as a process simulation program, linked to the independent variables, and where the optimization may be performed at a certain point in time for later use in polysilicon plant control, or may be linked in real time for on-line plant process control, and optionally where the value of the dependent variable may be optimized using a technique known in the industry as multi-variable optimization;
the temperature of the CVD off-gas fed to the absorber column is controlled between −20° C. and +100° C. or the temperature of the CVD off-gas fed to the absorber column is controlled between +10° C. and +70° C. or the temperature of the CVD off-gas fed to the absorber column is controlled between +20° C. and +60° C. or the temperature of the CVD off-gas fed to the absorber column is controlled at about +50° C.;
the temperature of the reflux fed to the absorber column is controlled between −20 C and +70 degrees centigrade, or the temperature of the reflux fed to the absorber column is controlled between +10° C. and +70° C. or the temperature of the reflux fed to the absorber column is controlled at +50° C.;
the weight ratio of the reflux to the absorber to the vent gas feed rate to the absorber is controlled between 0.2:1 to 2:1 or the weight ratio of the reflux to the absorber to the vent gas feed rate to the absorber is controlled between 0.4:1 to 1.75:1 or weight ratio of the reflux to the absorber to the vent gas feed rate to the absorber is controlled between 0.5:1 to 1.25:1 or the weight ratio of the reflux to the absorber to the vent gas feed rate to the absorber is controlled at 1:1;
the operating pressure of the absorber is controlled between 30 psig and 200 psig or the operating pressure of the absorber is controlled between 50 psig and 150 psig or the operating pressure of the absorber is controlled between 80 psig and 130 psig or the operating pressure of the absorber is controlled at about 90 psig.

As mentioned previously, any of the various embodiments described above can be combined to provide further embodiments. Aspects of the embodiments can be modified., if necessary to employ concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A process comprising:
a) introducing a vent gas comprising hydrogen, hydrochlorosilane and hydrochloric acid to an HCl converter reactor comprising a metal catalyst, and contacting the vent gas with the metal catalyst to provide a product gas comprising less hydrochloric acid than was present in the vent gas, and removing the product gas from the reactor;
b) separating components of the product gas to provide a first fraction enriched in hydrogen and second fraction enriched in chlorosilanes; and
introducing the second fraction into a distillation unit, to generate a third fraction enriched in trichlorosilane (TCS) and dichlorosilane (DCS) and a fourth fraction enriched in silicon tetrachloride (STC).

2. The process of claim 1 wherein step b) comprises introducing all of the product gas from step a) into an absorber column to provide the first and second fractions.

3. The process of claim 2 wherein the product gas from step a) is introduced into the bottom of an absorber column, reflux comprising at least one of TCS and STC is introduced into the top of the absorber column, the second fraction enriched in chlorosilanes is withdrawn as a liquid from the bottom of the absorber column, and the first fraction enriched in hydrogen is withdrawn as a gas from the top of the absorber column.

4. The process of claim 3 wherein the reflux comprises TCS and the first fraction comprises hydrogen and TCS.

5. The process of claim 3 wherein the reflux comprises STC and the first fraction comprises hydrogen and STC.

6. The process of claim 2 wherein the first fraction is introduced into a refrigerated condenser system to separate hydrogen from chlorosilanes.

7. The process of claim 1 wherein step b) comprises introducing all of the product gas from step a) into a refrigerated condenser system to provide the first fraction and the second fraction.

8. The process of claim 7 wherein the refrigerated condenser system comprises a refrigerator, refrigerant, a heat exchanger and a decantor.

9. The process of claim 1 wherein contacting a vent gas comprising hydrochloric acid, silicon tetrachloride, trichlorosilane, and dichlorosilane with a metal catalyst is performed at super-ambient temperature, and the product gas is maintained in a gas state at super-ambient temperature between exiting the HCl converter reactor and being separated into first and second fractions.

10. The process of claim 2 wherein the product gas is entirely in the gas phase upon being introduced into the absorber column.

11. The process of claim 6 wherein the product gas is entirely in the gas phase upon being introduced into the refrigerated condenser system.

12. The process of claim 1 wherein the first fraction comprising hydrogen is passed through a silica gel bed wherein boron is removed from the first fraction to provide a boron-depleted first fraction.

13. The process of claim 12 wherein the boron-depleted first fraction is passed through a refrigerated condenser system where gas phase chlorosilane is converted to liquid phase chlorosilane, while the hydrogen remains in a gas phase and exits the refrigerated condenser system as a purified H₂ gas stream containing less chlorosilane than does the boron-depleted first fraction.

14. The process of claim 13 wherein the purified H₂ gas stream is contacted with a carbon absorbent, and a residual amount of chlorosilane and optionally hydrocarbon in the purified H₂ gas stream is absorbed into the carbon absorbent to provide a highly pure H₂ gas stream containing less chlorosilane than does the purified H₂ gas stream.

15. A system comprising:
a) an HCl converter reactor;
b) an absorber column; and
c) a TCS/STC distillation unit;
where the absorber column is in fluid communication with and can receive vent gas exiting the HCl converter reactor, and where the TCS/STC distillation unit is in fluid communication with and can receive a liquid bottoms stream from the absorber column.

16. A system of claim 15 comprising:
a) an HCl converter reactor which may i) receive hydrogen, HCl and trichlorosilane, ii) consume HCl, and iii) produce silicon tetrachloride in the presence of a metal catalyst;
b) an absorber column which may i) receive hydrogen, trichlorosilane and silicon tetrachloride and ii) generate a first fraction comprising hydrogen and a second fraction comprising a mixture of trichlorosilane and the silicon tetrachloride;
c) a TCS/STC distillation unit which may i) receive a mixture of trichlorosilane and silicon tetrachloride and ii) separate the trichlorosilane from the silicon tetrachloride; and
d) a silica gel bed which may i) receive a composition comprising at least one of DCS and TCS and ii) absorb boron and/or phosphorus impurities from the composition.

17. A system comprising:
a) HCl converter reactor;
b) a refrigerated condenser system; and
c) a TCS/STC distillation unit;
where the refrigerated condenser system is in fluid communication with and can receive vent gas exiting the HCl converter reactor, and where the TCS/STC distillation unit is in fluid communication with and can receive an effluent stream from the refrigerated condenser system.

18. A system of claim 17 comprising:
a) an HCl converter reactor which may i) receive hydrogen, HCl and trichlorosilane, ii) consume HCl, and iii) produce silicon tetrachloride in the presence of a metal catalyst;
b) a refrigerated condenser system which may i) receive hydrogen, trichlorosilane and silicon tetrachloride and ii) generate a first fraction comprising hydrogen and a second fraction comprising a mixture of trichlorosilane and the silicon tetrachloride;
c) a TCS/STC distillation unit which may i) receive a mixture of trichlorosilane and silicon tetrachloride and ii) separate the trichlorosilane from the silicon tetrachloride; and
d) a silica gel bed which may i) receive a composition comprising at least one of DCS and TCS and ii) absorb boron and/or phosphorus impurities from the composition.

19. A vent gas recovery system that comprises a silica gel bed.

20. The vent gas recovery system of claim 19 further comprising an HCl converter reactor and a TCS/STC distillation unit.
